(19) United States
(12) Patent Application Publication
(10) Pub. No.: US 2014/0211499 A1
(43) Pub. Date: Jul. 31, 2014

(54) DEVICE WITH SIMULATED FLAME

(71) Applicant: Peter Sui Lun Fong, (US)

(72) Inventors: Peter Sui Lun Fong, Monterey Park, CA (US); Man Chuen Leung, Kowloon (HK); Kelvin Yat Kit Fong, Monterey Park, CA (US)

(73) Assignee: Peter Sui Lun Fong, Monterey Park, CA (US)

(21) Appl. No.: 13/750,597

(22) Filed: Jan. 25, 2013

(51) Int. Cl. F21S 10/04

(52) U.S. Cl. CPC F21S 10/046
USPC 362/558; 362/271; 362/157

(57) ABSTRACT

An artificial flame device is disclosed. There is an enclosure defining a lamp opening. A base stator assembly includes a base with a selectively activatable electromagnet, a post extending therefrom, and an electroluminescent device with a lens is mounted on the post. An articulation assembly is suspended from the base stator assembly. The articulation assembly has a lamp optic with a bearing coupled to the lens of the electroluminescent device. There is at least one extension defining a magnetic distal end that interacts with the electromagnet of the base in response to a selective activation thereof that induces rotation and movement of the articulation assembly within a predefined conical volume. The lamp optic protrudes from the lamp opening of the enclosure and diffuses light from the electroluminescent device passed thereto.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to illumination devices, and more particularly, to devices for simulating a flickering flame with artificial lighting effects.

2. Related Art

The earliest of artificial illumination modalities utilized fire, a process that involves the combustion of fuel that outputs light and heat. Examples of such earlier modalities include torches that are comprised of a wood rod soaked with flammable material, as well as lamps and candles that utilize a burning wick embedded in fuel.

The complex chemical and physical processes of a burning candle produce a continuously and randomly moving visible light or flame. In a steady state, the burning candle results in a heat transfer, by both convection and radiation, to the underlying wax. The heat melts the wax and creates a pool thereof underneath the wick. The melted wax ascends through the wick by capillary action, and vaporizes from the uppermost section of the wick. The buoyancy of the vaporizing fuel induces an ascending flow of air, and also entrains the air into the lower part of the flame. The vaporized fuel rises by convention and diffuses outwardly from the wick, which reacts with the surrounding oxygen from the air and forms the diffusion flame. As a result of this reaction at high temperatures, soot is formed, the particles of which are convected upwardly and penetrates a flame zone. The soot particles are oxidized via the surrounding air at a specific temperature range, which produces incandescence.

For most utilitarian purposes, the use of candlelight has been surpassed by electrical lighting systems. Electroluminescent devices include incandescent light bulbs, arc lamps, gas discharge lamps such as fluorescent lights, as well as lasers, light emitting diodes, and so forth. These devices have luminous intensity outputs that are orders of magnitude higher than candles, are longer lasting, and are more easily controllable by virtue of the inherent flexibility in the physical routing/distributing and switching of electricity networks. Although electricity has its share of risks and dangers, through the use of safety rated distribution equipment and updated wiring, those can be minimized to a greater degree relative to the unpredictable nature of open flames. Indeed, candles have been cited as one of the leading sources of residential fires in the United States, along with cooking equipment, heating equipment, and smoking.

Nevertheless, despite these dangers, candles continue to be used for numerous purposes. Candlelight is oftentimes regarded as having a soft and warm aesthetic, and is therefore used to set a relaxed mood in various contexts such as dining areas/restaurants, living rooms, bedrooms, and so on. Alternatively, candles are also used for religious ceremonies, holidays, and other special events. In some candles, the wax may also be infused with aromas that are released upon liquefaction and/or evaporation thereof. Furthermore, in the rare event the power grid is shut down, candles serve as backup lighting.

Inasmuch as any fire has the potential to rage out of control, so it can be as susceptible to extinguishment, particularly for a single flame of a candle. As noted, a steady state candle flame requires a continuous process of fuel evaporation, diffusion, and oxidization. By physically disrupting any one of the processes, such as, for example, a strong gust of wind, or an abrupt movement of the candle, the flame can be extinguished. The useful life of a candle is limited by its relatively quick consumption of wax. Further, for the noted potential dangers, best practices dictate that candles not remain lit unattended.

A safer alternative that simulates the aesthetics of candlelight that eliminates any open flames is therefore desirable. Again, as discussed earlier, the animated visual appearance of a flickering flame is dependent on the specifics of the fuel, temperature gradients, convection, and ambient airflow. Any minuscule physical disturbances with respect to any part of the above-described process can affect the appearance of the light output, so a typical candle flame exhibits subtle, flowing shifts in size, shape, color, and color gradients. Heretofore a convincing simulation of a flame that appears real and natural has proven elusive because of the difficulty with reproducing the nuanced flickering effects. The difficulty of simulating a single flame of a candle is compounded over simulating larger fires, partly due to the typical viewing distance, but also because of the nature of the effects to be mimicked. Thus, there is a need in the art for a more natural and realistic simulated flame device.

### BRIEF SUMMARY

The present disclosure contemplates various embodiments of an artificial flame device. There may be an enclosure that a lamp opening, and a base stator assembly that may include a base, a post extending therefrom, and an electroluminescent device that can be mounted on the post. The base may have a selectively activatable electromagnet, and the electroluminescent device may include or otherwise coupled to a lens. The device may further include an articulation assembly that is suspended from the base stator assembly. The articulation assembly may include a lamp optic that defines a bearing coupled to the lens of the electroluminescent device. It may also have at least one extension that defines a magnetic distal end that can interact with the electromagnet of the base. The interaction may occur in response to a selective activation of the electromagnet that induces rotation and movement of the articulation assembly within a predefined conical volume. The base stator assembly and the articulation assembly may be at least partially disposed within the enclosure. The lamp optic may protrude from the lamp opening of the enclosure and diffuse light from the electroluminescent device passed thereto.

In accordance with another embodiment, a flame simulation apparatus is disclosed. The apparatus may include a stator base with a selectively activatable first electromagnet. Additionally, there may be a post extending from the stator base. An electroluminescent device with a case defining a first joint element may be mounted on the post. The apparatus may also include a lamp optic assembly with a bearing surface defining a second joint element. The first joint element of the case may be rotatably engaged to the second joint element of the bearing surface. An interface of the bearing surface and the case may define a pivot point. There may also be a swing plate with the lamp optic assembly coaxially mounted thereto, as well as at least one extension from the swing plate that may have a magnetic element. Such magnetic element may interact with the first electromagnet to induce movement of the swing plate about the pivot point.

Yet another embodiment involves a lamp optic for simulating a flame in cooperation with an electroluminescent device. The lamp optic may include a cover with a hollow interior. Furthermore, it may include a base defined by a first side and an opposed, second side. The first side may interface an interior of the cover, while the second side may define a bearing surface that is engageable to a lens that is focally aligned with a radiation axis of the electroluminescent device. In some embodiments, the cover may be coupled to the base. The lamp optic may further include a gap defined between the cover and the base. Light generated by the electroluminescent device may be transmitted to the base through the bearing surface thereof and dispersed through the base and the cover. The cover and the base may define a plurality of overlapping regions of diffusion surface layers that reflects and refracts the light in varying degrees depending on the specific region from which the light is output. The regions may be arranged for a resultant light output to simulate varying illumination intensity areas of a natural flame.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1A is a perspective view of one embodiment of a flame simulation apparatus implemented as a candle;

FIG. 1B shows another embodiment of the flame simulation apparatus implemented as a glowing decoration item (snowman);

FIG. 2 is an exploded perspective view of the flame simulation apparatus shown in FIG. 1;

FIG. 3 is a side cross-sectional view of the flame simulation apparatus shown in FIG. 1 and FIG. 2;

FIG. 4A-4C are detailed side cross-sectional views of different embodiments of a lamp optic and a base adapter by which the articulation assembly is suspended from the base stator assembly;

FIG. 5 is a perspective view of another embodiment of the articulation assembly and the base assembly implemented as a universal joint;

FIG. 6 is a perspective view of the gimbals of the universal joint;

FIG. 7A is an exploded perspective view of another embodiment of the articulation assembly including an annular track;

FIG. 7B is a perspective view of the articulation assembly shown in FIG. 7A;

FIG. 8 is an exploded perspective view of still another embodiment of the articulation assembly with angled swing arms;

FIG. 9 is an exploded perspective view of a base assembly locking mechanism;

FIG. 10A is a side cross-sectional view of the flame simulation apparatus shown in FIG. 9 with the locking mechanism in a locked position;

FIG. 10B is a side cross-sectional view of the flame simulation apparatus shown in FIG. 9 with the locking mechanism in an unlocked position;

FIG. 11 is an exploded perspective view of the flame simulation apparatus with an embodiment of the base assembly including a lever operative to reciprocate a post of the base assembly;

FIG. 12A is a side cross-sectional view of the post of the base assembly shown in FIG. 11 in a retracted position;

FIG. 12B is a side-cross sectional view of the post of the base assembly shown in FIG. 11. in a fully extended position;

FIG. 13 is an exploded perspective view of one embodiment of a post of the base assembly with vertical movement;

FIG. 14A is a side-cross sectional view of the post shown in FIG. 13 in a retracted position;

FIG. 14B is a side-cross sectional view of the post shown in FIG. 13 in an extended position;

FIG. 15A-15D are detailed side cross-sectional views of different embodiments of the lamp optic and a bearing thereof for suspending the articulation assembly from the base stator assembly; and

FIG. 16 is a side cross-sectional view of the flame simulation apparatus with one embodiment of a fixed cover;

FIG. 17 is a side cross-sectional view of the flame simulation apparatus with another embodiment of the fixed cover;

FIG. 18 is a side-cross sectional view of the flame simulation apparatus including an acoustic transducer; and

FIGS. 19A-1, 19A-2, 19A-3, 19B-1, 19B-2, 19B-3, 19C-1, 19C-2, and 19C-3 are schematic diagrams of a circuit board utilized in various embodiment of the flame simulation apparatus; and

Common reference numerals are used throughout the drawings and the detailed description to indicate the same elements.

### DETAILED DESCRIPTION

The detailed description set forth below in connection with the appended drawings is intended as a description of the presently preferred embodiments of an artificial flame device, and is not intended to represent the only form in which the present invention may be constructed or utilized. The description sets forth the functions of the invention in connection with the illustrated embodiment. It is to be understood, however, that the same or equivalent functions and may be accomplished by different embodiments that are also intended to be encompassed within the scope of the present disclosure. It is further understood that the use of relational terms such as first and second, distal and proximal, and the like are used solely to distinguish one from another entity without necessarily requiring or implying any actual such relationship or order between such entities.

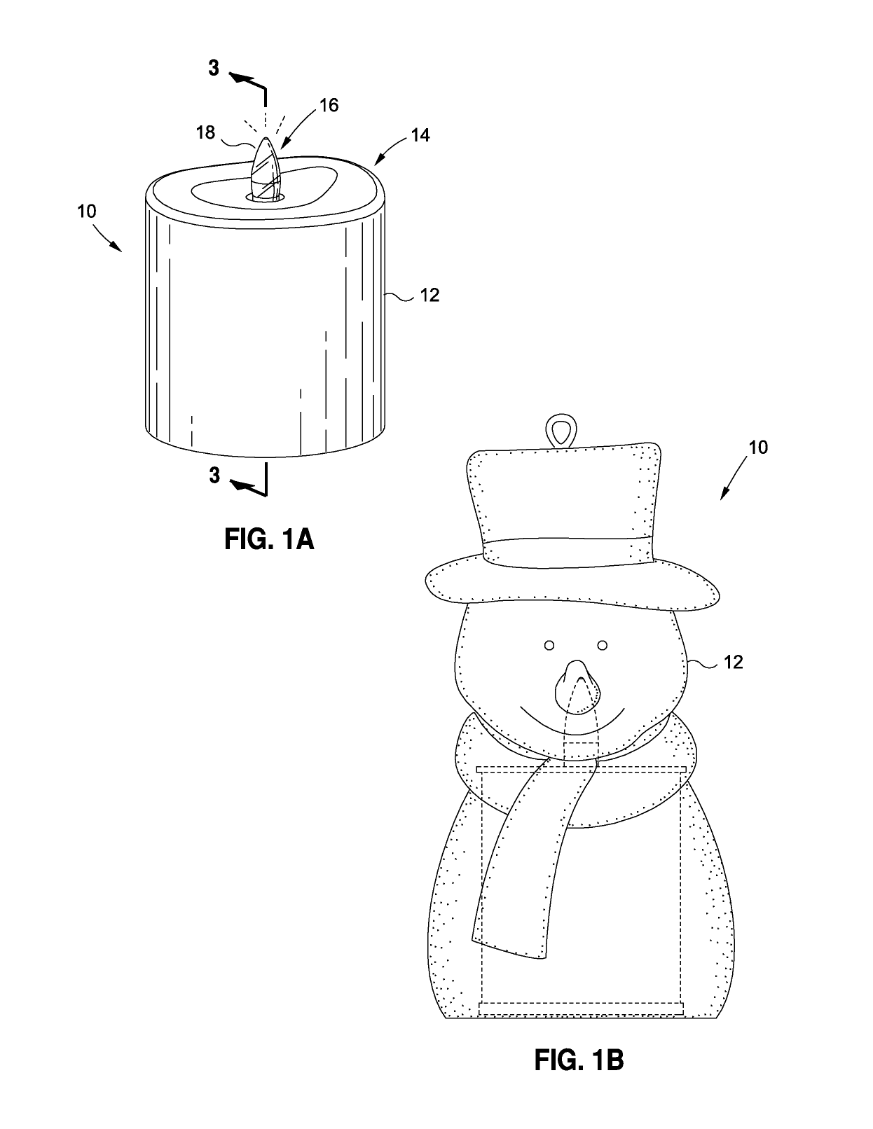

With reference to FIG. 1A, various embodiments of the present disclosure contemplate an artificial flame device 10. The particular example shown mimics the appearance of a candle, and accordingly has an enclosure cover 12 characterized by a cylindrical candle body with an irregularly shaped top end 14 simulating the random melting effects of candle wax. Protruding centrally from within the enclosure cover 12 is a lamp element 16 that emits an animated illumination 18, the details of which will be described more fully below. Although this and other embodiments of the artificial flame device 10 are illustrated and described in the context of the enclosure cover 12 appearing as a candle, this is by way of example only and not of limitation. For example, with a differently configured enclosure cover 12, gas lamps, torches, and other flame-based illumination sources could be simulated. Moreover, the enclosure cover 12 could be seasonal decoration elements such as jack-o-lanterns, Santa dolls, and so forth. For example, FIG. 1B illustrates another embodiment in which the enclosure cover 12 is a snowman decoration. The enclosure cover 12 is understood to be hollow, and is constructed of a plastic, or a transparent poly resin. The cover 12 may be painted with various colors as well. The presently contemplated artificial flame device 10 could be utilized in any scenario where a single flame effect illumination is desired.

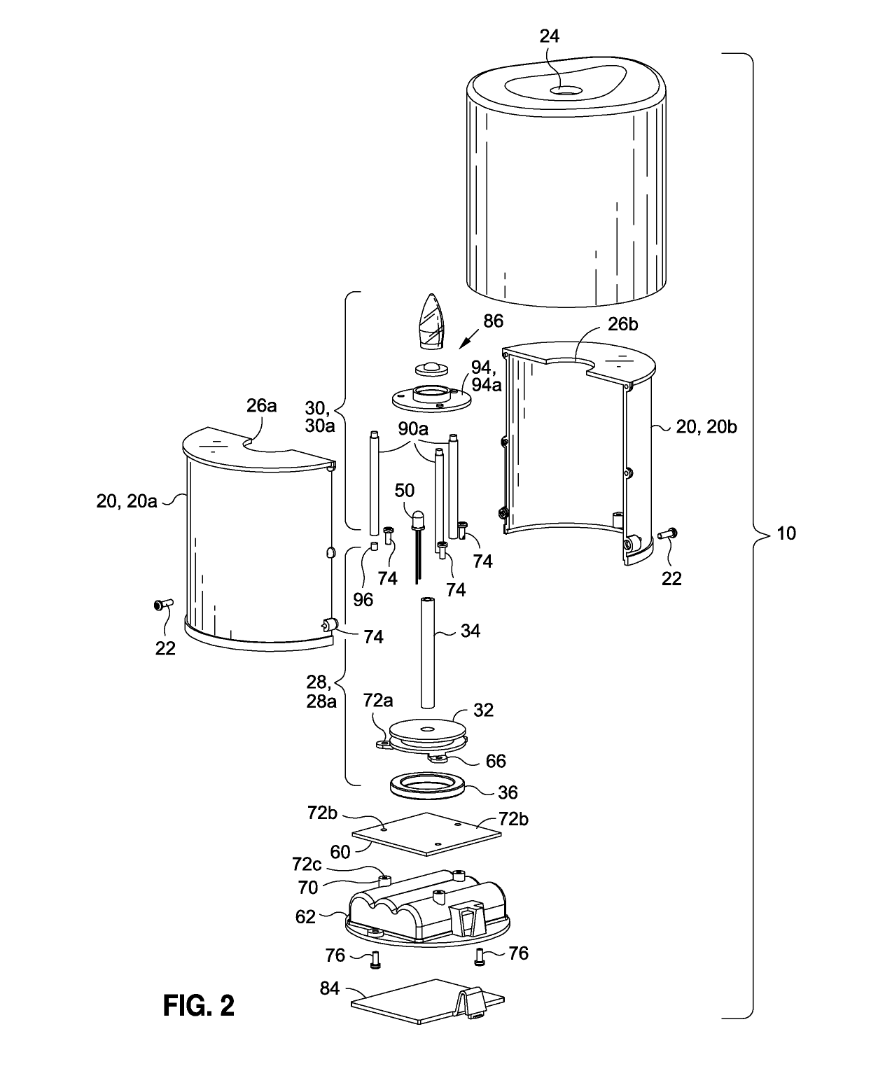

FIG. 2 shows an exploded view of the components of the artificial flame device 10, which in addition to the aforementioned enclosure cover 12, there is an enclosure shell 20 over which the enclosure cover 12 is fitted. In some embodiments, the enclosure cover 12 and the enclosure shell 20 are integral, but a separate enclosure cover 12 is contemplated for interchangeability with those having different appearances, either by the end-user, or at the point of manufacture. In the illustrated embodiment, the enclosure shell 20 is comprised of a first enclosure shell half 20a and a second enclosure shell half 20b. The two halves are attached to each other by fasteners 22. Both the enclosure cover 12 and the enclosure shell 20 define respective lamp openings 24, 26, through which the lamp element 16 protrudes.

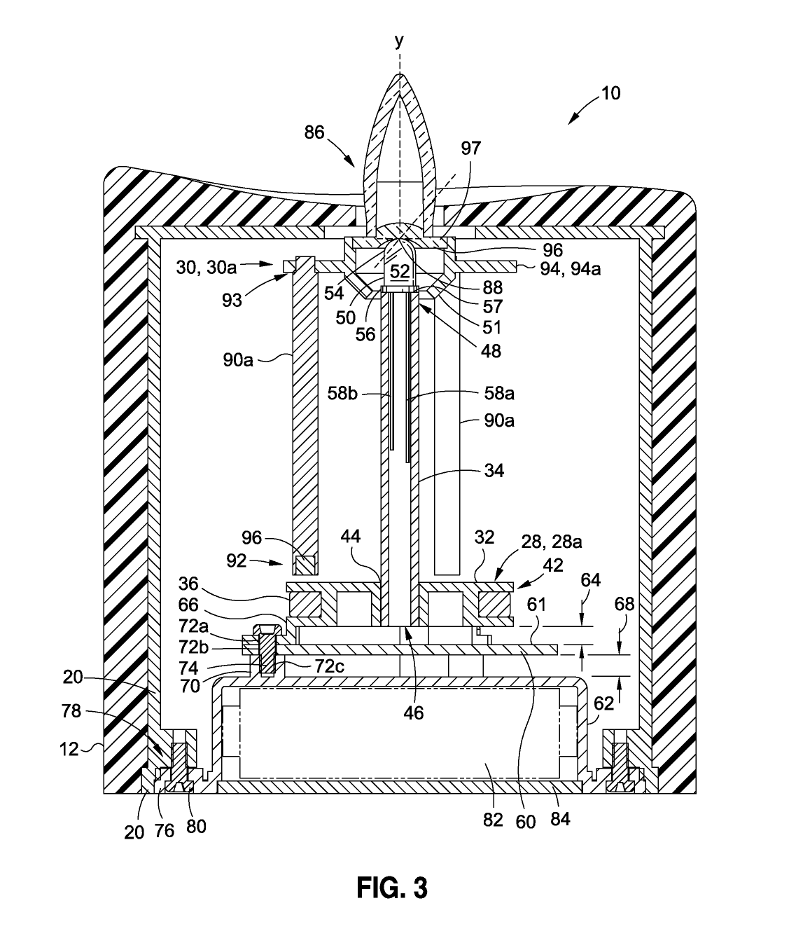

The present disclosure generally envisions simulating the appearance of a flame, and in accordance therewith, one aspect pertains to mimicking the kinetic behavior thereof, while another aspect pertains to mimicking the illumination color and intensity gradients thereof. These aspects will be described in turn, with further particularity. Referring to FIG. 2 and FIG. 3, the operative components of the artificial flame device 10 include a base stator assembly 28 and an articulation assembly 30 that is suspended therefrom. Generally, the articulation assembly 30 rotates and swings freely relative to the base stator assembly 28 within a predefined conical volume and mimics the articulation of a ball-and-socket joint.

Although various enhancements, variations, and additional features are contemplated for the base stator assembly 28, in its most basic form as a first embodiment 28a, it is comprised of a base 32 having a flat configuration and a post 34 extending vertically therefrom. As will be described in further detail below, magnetic interaction between the articulation assembly 30 and the base stator assembly 28 induces movement of the articulation assembly 30. To this end, the base stator assembly 28 includes a selectively activatable electromagnet 36. The electromagnet 36 may be comprised of a single spool of wound electrically conductive wiring, preferably of copper, connected to an electrical power source. Varying levels of current may be applied to the electromagnet 36 in predetermined time sequences to induce a proportional amount of magnetic interaction, i.e., proportional repelling and attracting forces, at set intervals. As will be appreciated by those having ordinary skill in the art, the electromagnet 36 may be variously configured, and the example shown in FIG. 3 is by way of example only and not of limitation. Depending on the magnetic attraction/repelling forces deemed optimal for any particular application, other types of electromagnets such as those with ferrous cores may be substituted. Furthermore, there may be more than a single electromagnet 36, in that there may be a pairs or more of radially opposed electromagnets 36 that are spaced around the base 32. In this regard, the base 32 may define an electromagnet receptacle 42 that is sized and configured to retain the electromagnet 36 by friction or otherwise.

Similarly, the base 32 may define a central slot 44 through which the post 34 is inserted and frictionally retained by interference fit. The post 34 is defined by a bottom end 46 that is attached to the base 32, and an opposed top end 48. Although in the illustrated embodiments the post 34 and the base 32 are separate, independent components, it is also possible for these two parts to be integral. The post 34 is understood to be a hollow tube with open ends. Mounted to the top end 48 is an electroluminescent device 50 with a case 52 having a semi-spherical, or domed lens 54 and flange portion 56. At a minimum, a lip 57 defining the open top end 48 frictionally engages the flange portion 56 of the case 52, though other modalities for further securing the electroluminescent device 50 to the post 34 are also possible, such as glue, mounting sockets, and the like. Those having ordinary skill in the art will readily recognize such alternative modalities. The top end 48 of the post 34 may further include a cone-shaped reflector 51 disposed underneath the electroluminescent device 50, to collect and focus upwards the omnidirectional light.

In accordance with one embodiment, the electroluminescent device 50 is a light emitting diode (LED) in a conventional through-hole package where the case 52 is constructed of clear and transparent epoxy for optimal transmission of light. However, alternative packaging modalities for the electroluminescent device 50 are also possible, but with the addition of a suitable domed surface component, one embodiment of which is discussed more fully below, that can substitute for the domed lens 54 in an otherwise conventional LED package. The electroluminescent device 50 is understood to output light in response to electrical current provided to the embedded semiconductor device, and varying voltage levels may be applied to generate proportional illumination intensities. Furthermore, the electrical power provided to the electroluminescent device 50 can be intermittent or time-varied. To so provide the semiconductor device with electrical power, the electroluminescent device 50 has leads 58, including a positive (+) lead 58a and a negative (−) lead 58b. The leads 58 are routed to a power source via conductive traces, wires, etc. Those having ordinary skill in the art will appreciate that different LED devices can emit light of different color wavelengths, and indeed, there are multiple color emission LED devices with Red, Green, and Blue (RGB) outputs that can be selectively combined to yield any desired color. In accordance with several embodiments, simulation of a candle flame may be most convincing with a yellow-orange emission. Color variations to mimic different natural flames are also possible, however.

As mentioned above, several contemplated features involve the intermittent delivery of variable electric power levels. For example, the electromagnet 36 may be activated at a high power level for one duration, deactivated for another duration, and activated at a lower power level for another duration. Additionally, the electroluminescent device 50 may pulsate with higher and lower illumination intensities in a gradually changing fashion. The particular output levels and interval sequences may be pre-programmed in an integrated circuit implemented on a circuit board 60, the details of which will be considered more fully below. Therefore, there may be electrical connections between the circuit board 60 and the leads 58 of the electroluminescent device 50 as well as from the wiring of the electromagnet 36. Because the bottom end 46 of the post 34 and the central slot 44 are open, and the interior of the post 34 is hollow, any connections between the leads 58 and the circuit board 60 can be directly routed without additional connection interfaces aside from those on a top surface 61 of the circuit board 60. Similarly, electrical connections between the wiring and the circuit board 60 may be routed through vias defined in the base 32, and then to the top surface 61.

Different embodiments may involve a single integrated circuit to control both the electroluminescent device 50 and the electromagnet 36. Alternatively, there may be a separate light regulator circuit that performs the aforementioned function of periodically varying the intensity of light output from the electroluminescent device 50, as well as a separate movement regulator circuit that selectively activates the electromagnet 36. Another implementation may logically separate the circuit into these functional divisions, but may combined as a single physical circuit or integrated circuit device. It will be recognized there are many possible variations with respect to the implementation of the integrated circuit and the circuit board 60. For instance, it is possible to miniaturize some of the components of the circuit board 60 into a separate integrated circuit for light regulation or control, and embedded within the electroluminescent device. Any such variation is deemed to be within the scope of the present disclosure.

The base stator assembly 28 may be fixed relative to the swinging, rotating articulation assembly 30. More particularly, the base 32 is attached to a battery housing 62 that is in turn, fixed to the enclosure shell 20. Interposed between the base 32 and the battery housing 62 is the circuit board 60, and there may be a first stand-off 64 defined by legs 66 extending from the base 32 to vertically offset the base stator assembly 28 from the circuit board 60. Additionally, there may be a second stand-off 68 defined by risers 70 on the battery housing 62 to vertically offset the circuit board 60 from the battery housing 62. The base 32, circuit board 60, and the risers 70 of the battery housing 62 each define respective coaxial holes 72a-c through which a fastener is inserted. The battery housing 62 includes couplings 76 mating with corresponding notches 78 on the bottom of the enclosure shell 20. Another set of fasteners 80 fix the battery housing 62 to the enclosure shell 20.

Various battery types can be utilized in connection with the artificial flame device 10, but in the embodiment illustrated in FIG. 2 and FIG. 3, an AAA or AA type battery 82 with an elongated, cylindrical configuration is used. The electrical contacts for the battery terminal frictionally retain the battery 82 to some extent, though to prevent dislocation, there is a cover 84. The electrical power provided by the battery 82 is understood to be utilized by the aforementioned integrated circuits to generate appropriate signals to the electromagnet 36 and the electroluminescent device 50.

The articulation assembly 30, and more particularly, a lamp optic 86 thereof rotates and swings freely relative to the base stator assembly 28. In further detail, the lamp optic 86 defines a concave bearing 88, also referred to as a second joint surface that is engaged to the domed lens 54, also referred to as a first joint surface, of the electroluminescent device 50. In other words, the lamp optic 86 is balanced on the electroluminescent device 50 at a pivot point defined by the interface of the domed lens 54 and the bearing 88. Accordingly, the lamp optic 86 can freely move in two planes concurrently, as well as rotate about those planes, subject to the limitations imposed by the extent of the bearing 88. It is also understood that movement of the lamp optic may be restricted by the periphery of the lamp opening 24 of the enclosure cover 12, and/or the periphery of the lamp opening 26 of the enclosure shell 20. While each of the examples shown herein contemplate the lens 54 being domed or having a convex surface and the lamp optic 86/bearing 88 having a concave surface, it is understood that alternative configurations where the profile is reversed, i.e., the bearing 88 is convex while the lens is concave, may be readily substituted upon a simple reconfiguration of the foregoing components. Any other variation which allows for similar articulation is also deemed to be within the scope of the present disclosure.

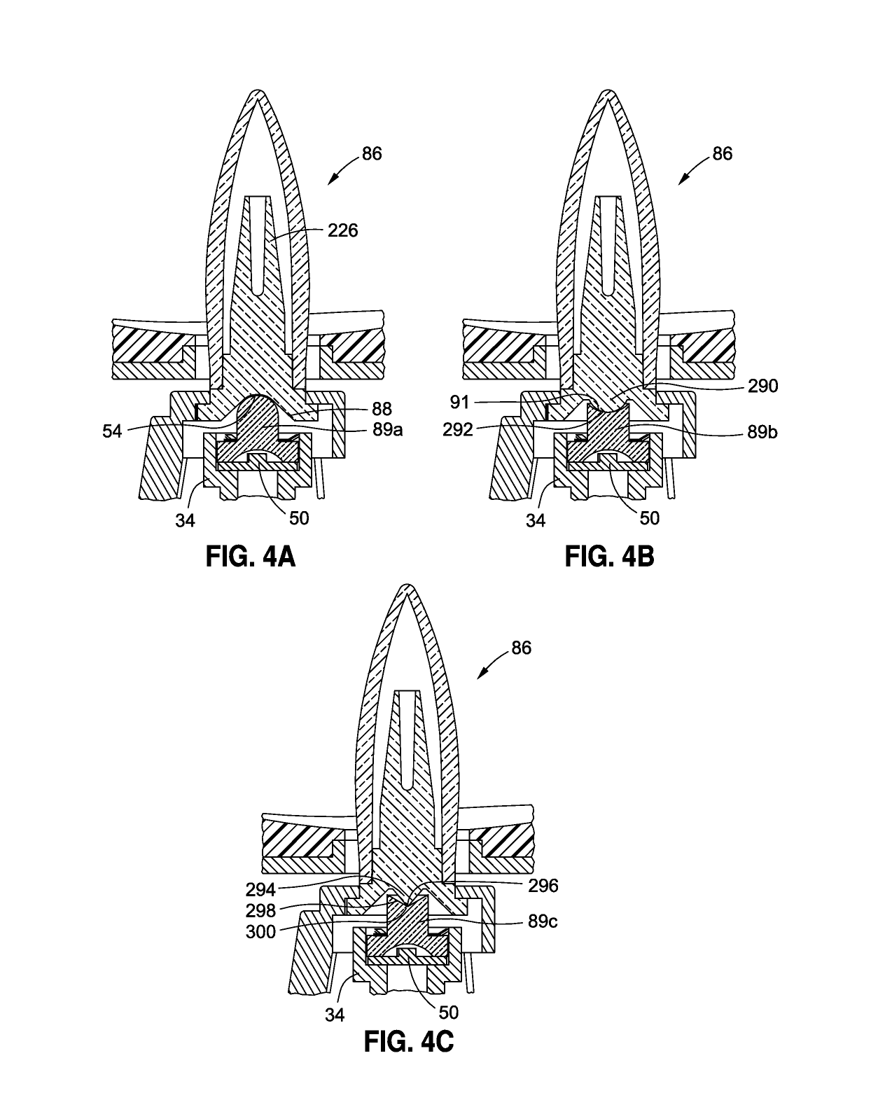

Several variations of the suspended mounting of the articulation assembly 30 from the base stator assembly 28 are illustrated in FIGS. 4A, 4B, and 4C. The embodiment illustrated in FIG. 4A in particular contemplates the same lamp optic 86 with a concave bearing 88. As will be explained in further detail below, the lamp optic includes a base element 226. For purposes of the following discussion regarding the features directed to the suspended engagement of the articulation assembly 30 from the base stator assembly 28, references to the lamp optic 86 are understood to cover any references to the base element 226.

Instead of directly engaging the electroluminescent device 50 as with the above-described embodiments, a lens adapter 89, and a first embodiment 89a thereof that is mounted to the post 34, is contemplated. As shown, the electroluminescent device 50 is in a surface mount device package, with no domed lens. The lens adapter 89 is a substitute for such a conventional LED package, and accordingly includes the domed lens 54 that interfaces the bearing 88 of the lamp optic 86. Whether the lens 54 is part of the LED package or not, it is understood to be focally aligned with a radiation axis of the electroluminescent device 50, that is, light generated by the electroluminescent device 50 travels through the lens 54. Aside from the substitution of the domed lens 54 of the electroluminescent device 50 with the lens adapter 89, the freely rotating and swinging functionality of the lamp optic 86 and the articulation assembly 30 relative to the base stator assembly 28 is understood to be the same as discussed above in relation to the other embodiments.

A different embodiment in which the concave/convex relationship of the lamp optic 86 and the domed lens 54 is reversed is illustrated in FIG. 4B. The lamp optic 86 instead has a semi-spherical protuberance 290 that defines a convex bearing 91, while the opposed lens adapter 89, and in particular a second embodiment 89b thereof, defines a concave top surface 292. As with the variation discussed above, the lens adapter 89 is mounted to the post 34. The convex bearing 91 is understood to define the first joint surface that engages the second joint surface corresponding to the concave top surface 292 of the lens adapter 89. In this configuration, the electroluminescent device 50 is also understood to be in a surface mount device package without a domed lens.

Yet another variation of the lamp optic 86 and the lens adapter 89 is shown in FIG. 4C. Again, the electroluminescent device 50 does not have any surfaces to which the lamp optic 86 can be rotatably engaged. Accordingly, this embodiment also utilizes a lens adapter 89, and in particular a third embodiment 89c thereof that is mounted to the post 34. The lamp optic 86 includes a conical protuberance 294 defining a balance point 296. The lens adapter 89 has a correspondingly shaped conical groove 298 defining a bearing point 300 to which the conical protuberance 294 is engaged. Like the earlier described embodiments, however, the lamp optic 86 is balanced on the lens adapter 89 at the pivot point defined by the interface of the balance point 296 and the bearing point 300, and the lamp optic 86 can freely move in two planes concurrently, as well as rotate about those planes.

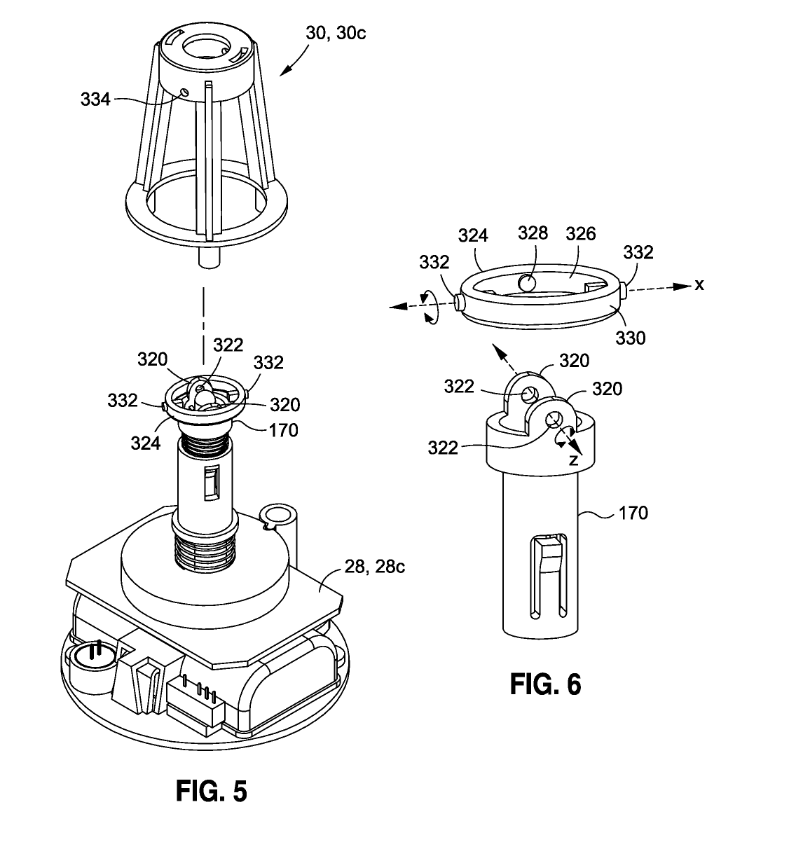

The present disclosure contemplates another way to movably mount the articulation assembly 30 to the base stator assembly 28 with a universal joint or gimbal mechanism. With reference to FIG. 5 and FIG. 6, such a configuration will be discussed. The illustrated example shows a third embodiment 30c of the articulation assembly as well as a second embodiment 28b of the base stator assembly. The features of these particular embodiments have not yet been considered, though additional details thereof will follow. A preferred, though optional embodiment may include these components, but the specifics thereof are not necessary to a consideration of the alternative universal joint or gimbal mechanism to movably mount the articulation assembly 30 to the base stator assembly 28. To the extent specific aspects of these components are pertinent to a feature or function of the universal joint, those aspects will be mentioned, though a more full treatment thereof will be made in the appropriate parts of the present disclosure specific to those embodiments. In this regard, reference to the third embodiment 30c and the third embodiment 28c of the articulation assembly and the base stator assembly, respectively, are not intended to be limiting. Those having ordinary skill in the art will be readily capable of adapting the various embodiments of these components also discussed herein to utilize the universal joint feature instead.

The base stator assembly 28 includes a fixed post 170 that includes a pair of opposed journals 320 extending therefrom, which each journal 320 defining a first pivot shaft hole 322. As best shown in FIG. 6, there is a gimbal 324 having an annular structure. On opposed ends of an interior side 326 of the gimbal 324 are first pivot shafts 328 that are pivotally engaged to the first pivot shaft hole 322. Thus, the gimbal 324, along with any components coupled thereto including the articulation assembly 30, is rotatable about the referenced z axis. On opposed ends of an exterior 330 side of the gimbal 324 are second pivot shafts 332. The articulation assembly 30 defines a pair of opposed second pivot shaft holes 334, to which the second pivot shafts 332 are pivotally engaged. Thus, the articulation assembly 30 rotates about the illustrated x axis relative to the gimbal 324. In order to maximize articulation range, the first pivot shafts 328, along with the journal 320 and the first pivot shaft holes 322 to which they are engaged, are oriented orthogonally to the second pivot shafts 332 as well as the second pivot shaft holes 334 on the articulation assembly 30. The foregoing configuration thus permits limited movement of the articulation assembly 30 about the aforementioned x and y axes.

The lamp optic 86 attaches to one or more extensions of a first embodiment 90a that have a magnetic distal end 92, which interacts with the aforementioned electromagnet 36 to induce rotation and movement of the articulation assembly 30. In this regard, the magnetic distal end 92 of the extensions 90a can be magnetized in various ways, depending on the particulars of the material utilized. One variant envisions the extensions 90a being constructed of plastic, with a permanent magnet element 96 embedded within. Each of the extensions 90a may include the permanent magnet element 96, or just one of the multiple extensions 90a may. Those having ordinary skill in the art will recognize the possible alternative configurations for the magnetic distal end 92. The extensions 90a may also be referred to as swing arms.

The first embodiment of the articulation assembly 30a shown in FIG. 2 and FIG. 3 incorporates a first embodiment of an annular swing plate 94a to which a flange portion 97 of the lamp optic 86 is coaxially mounted. Further, the extensions 90a, and more particularly, proximal ends 93 thereof, are attached to the annular swing plate 94a and extend perpendicularly therefrom. In one embodiment, the proximal ends 93 of the extensions 90a are retained by interference fit through a hole defined by the annular swing plate 94a. Other securement modalities are also possible, and deemed to be within the scope of the present disclosure. There are three vertical extensions 90a spaced equidistantly around the circumference of the annular swing plate 94a, though other embodiments are also contemplated. In any case, the extensions 90a are positioned such that the balance of the articulation assembly 30 on the base stator assembly 28 is maintained.

The length of the extensions 90a is partially dependent on the length of the post 34, and ultimately, the height of the enclosure shell 20. Preferably, there is to be sufficient clearance between the electromagnet 36 and the permanent magnet element 96 such that an energized electromagnet 36 can exert kinetic influence over the permanent magnet element 96, but not so close that the two components become attached to each other. In this regard, the strength of the permanent magnet element 96 and the electromagnet 36 may also affect the length of the extensions 90a, albeit in minimal increments.

The force imparted to the extensions 90a is translated to movement of the annular swing plate 94a, and hence the lamp optic 86. As a result of illumination generated by and transmitted from the electroluminescent device 50, the lamp optic 86 is illuminated and diffuses light in a particular way, the details of which will be described more fully below. Furthermore, such illumination is understood to exhibit a slight rotation and side-to-side swaying that mimics the flowing movement of a natural flame.

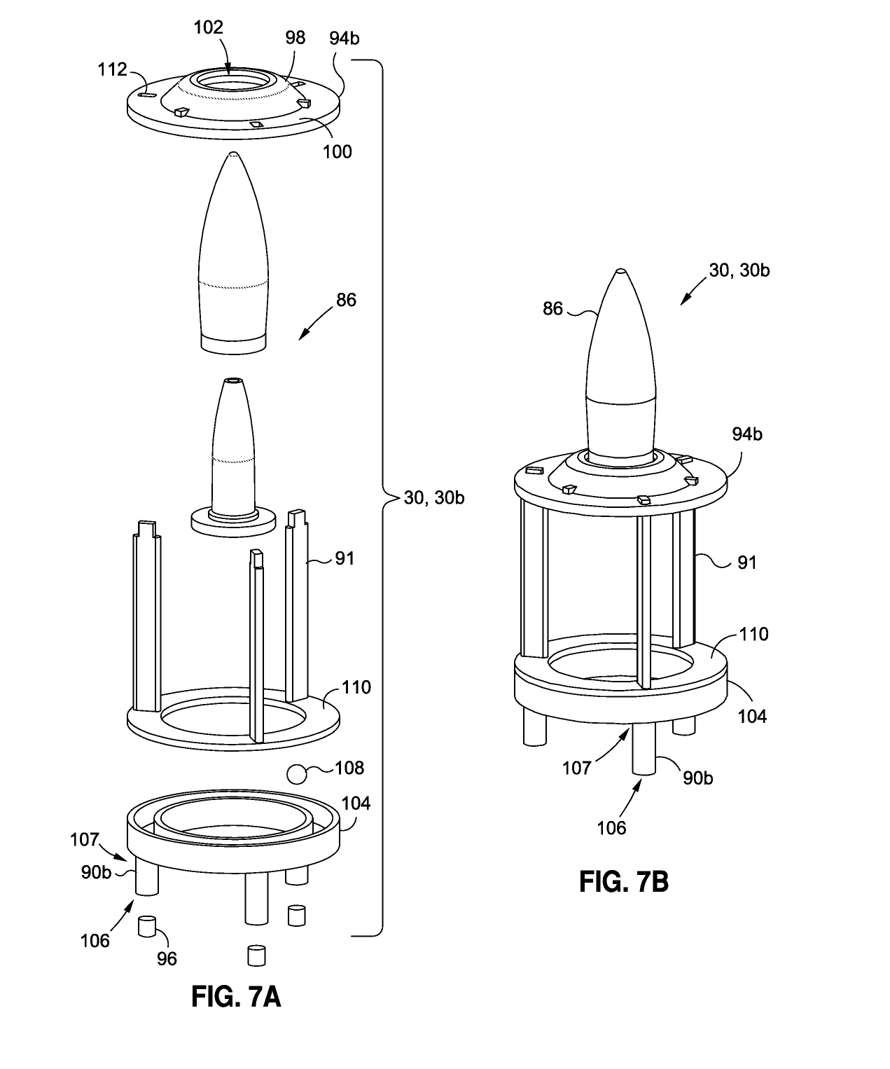

A second embodiment of the articulation assembly 30b shown in FIG. 7A and FIG. 7B utilizes the similar lamp optic 86 as the first embodiment 30a. However, instead of the lamp optic 86 being mounted to the top of the annular swing plate 94a, it is secured from the bottom. A second embodiment of the annular swing plate 94b has a tapered inner portion 98 encompassed by a flange outer portion 100, and a central opening 102, through which the lamp optic 86 is attached. Different modalities for securing such attachment are possible, and will be recognized by those having ordinary skill in the art.

Unlike the first embodiment of the extensions 90a that directly attaches to the swing plate 94, a second embodiment of the extensions 90b are attached to an annular track 104 and hence is only indirectly attached to the annular swing plate 94b. In this regard, the extensions 90b are understood to be separate from swing arms 91 that attach to the annular swing plate 94b. Again, the distal ends 106 of the extensions 90b are magnetic, in that there are embedded permanent magnet elements 96. The proximal ends 107 of the extensions 90b are attached to the annular track 104. Optionally, a counterweight 108 freely moves within the confines of the annular track 104 to dampen the movement and acceleration of the articulation assembly 30. In the illustrated embodiment, the counterweight 108 is a single weighted metallic ball bearing, but it is understood that multiple ball bearings may be utilized. Rather than utilizing such a metallic ball bearing, different embodiments may also utilize a fluid counterweight to achieve improved balancing.

The swing arms 91 are integrally formed with an annular cover 110 that fits over the annular track 104. As such, the annular cover 110 is understood to be sized and shaped to substantially encompass the open annular track 104. The annular swing plate 94b defines correspondingly positioned slots 112 that align with the arrangement of the swing arms 91 around the circumference of the annular cover 110. As with the first embodiment of the extensions 90a/swing arms, the swing arms 91 are positioned equidistantly from each other for balanced weight distribution. Different from the cylindrical configuration of the first embodiment of the extensions 90a/swing arms, however, the swing arms 91 have a flat bar configuration.

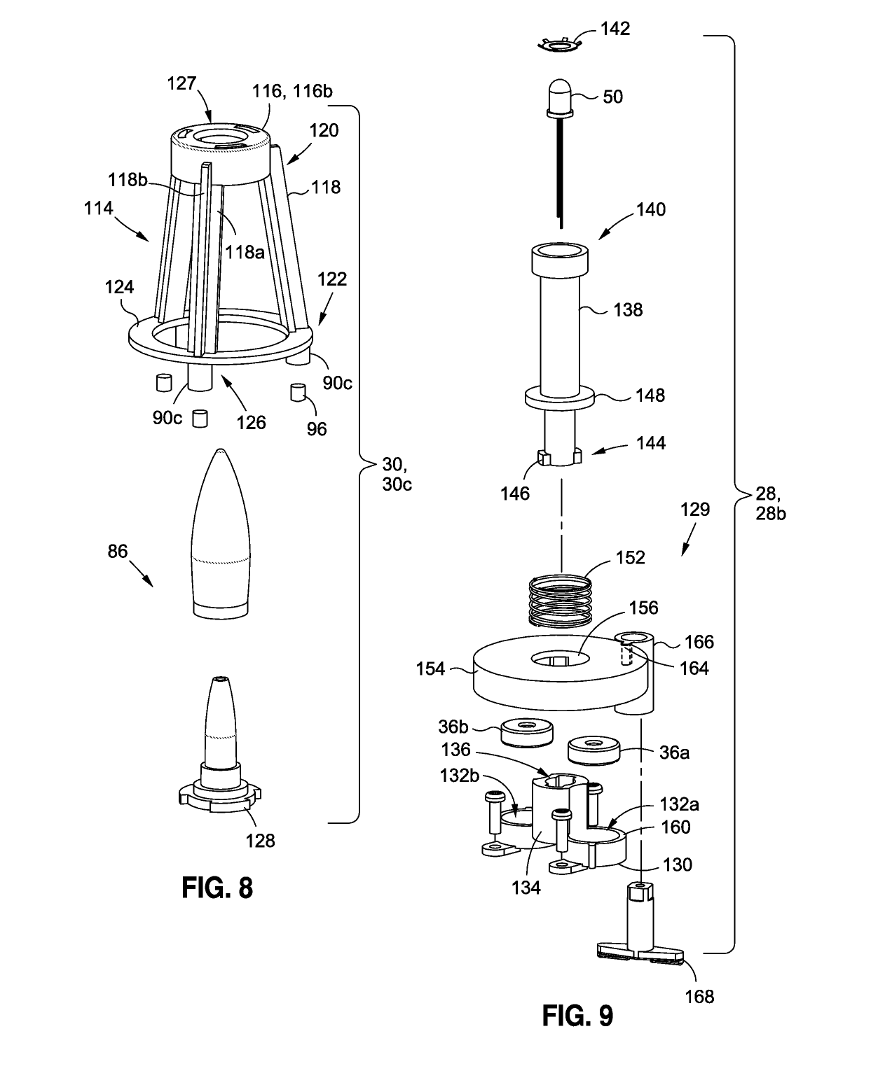

FIG. 8 depicts yet another third embodiment of the articulation assembly 30c. There is an integrated carriage 114 that includes another embodiment of a swing plate 116b to which a plurality of swing arms 118 is attached. Each of the swing arms 118 are comprised of a flat bar 118a with a perpendicular reinforcement rib 118b, the proximal ends 120 of which are connected to the swing plate 116b and the distal ends 122 of which are connected to annular support 124. The swing arms 118 are angled, as the annular support 124 has a larger circumference than that of the swing plate 116. Extending perpendicularly relative to the bottom surface of the annular support 124 are the third embodiment of the extensions 90c. The distal ends 126 of the extensions 90c include the permanent magnet elements 96.

The lamp optic 86 is secured to the swing plate 116b from its underside and extends through a central hole 127 defined thereby. Radial tabs 128 of the lamp optic 86 engage corresponding locking members within the swing plate 116.

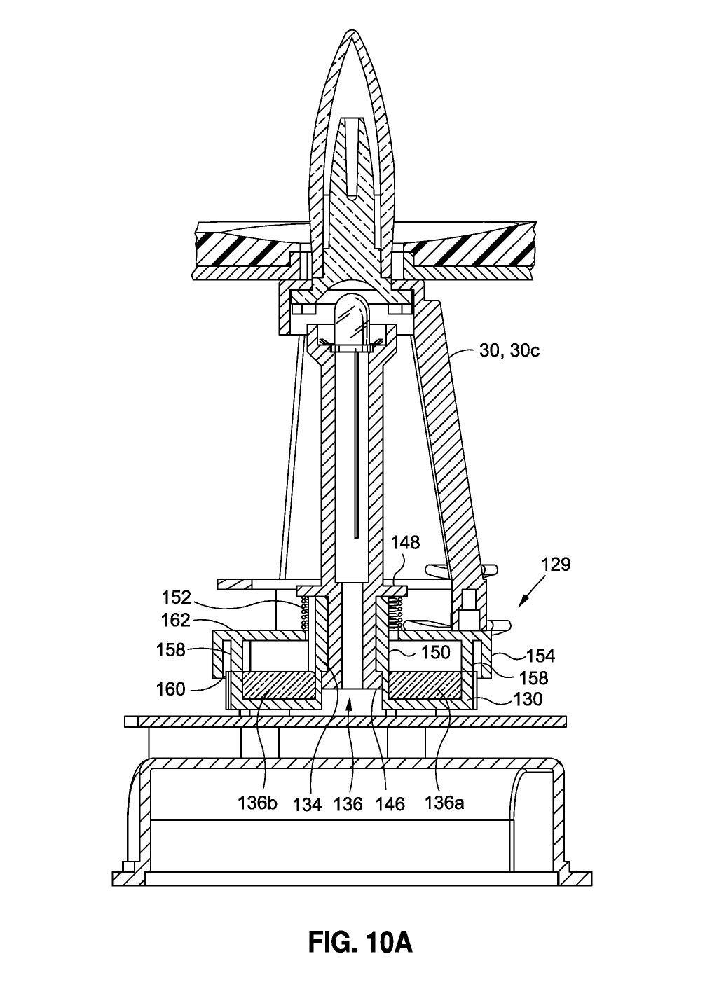

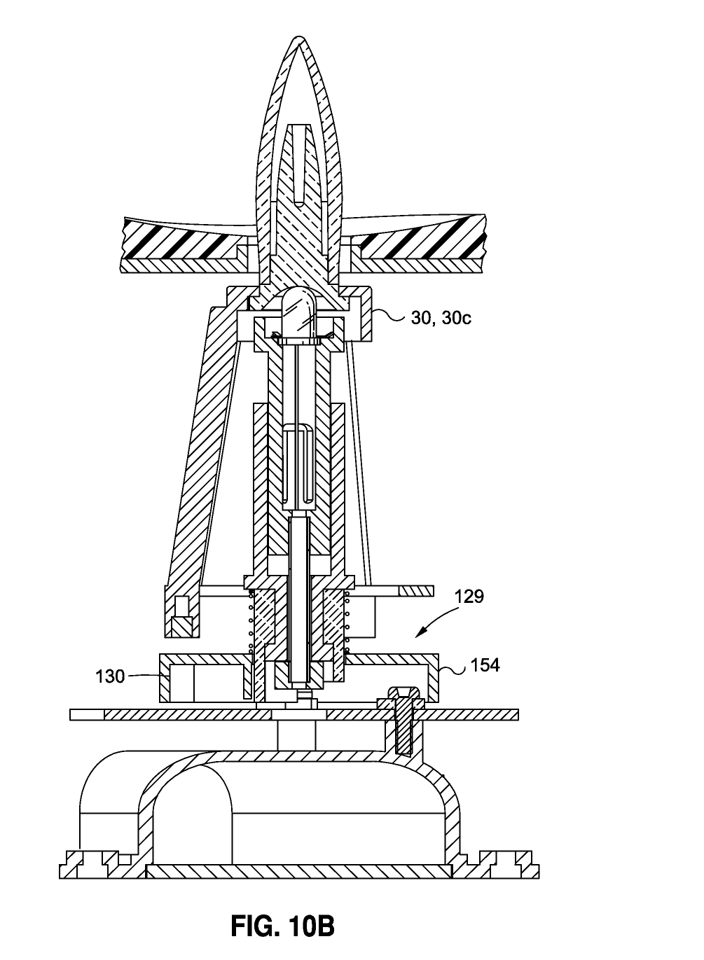

It will be appreciated that the articulation assembly 30 being suspended and free to move about the base stator assembly 28 may be problematic during shipping. Constantly being subject to shock, the various components may experience premature wear, or worse, may become damaged. To avoid this problem, the present disclosure contemplates a locking mechanism 129 that is further described below with reference to FIG. 9, FIG. 10A, and FIG. 10B. This locking mechanism 129 may be incorporated in an exemplary second embodiment of the base stator assembly 28b. In further detail, an alternative configuration of a base 130 has separate electromagnet receptacles 132a and 132b for a first electromagnet 36a and a second electromagnet 36b, respectively. It is understood that the first and second electromagnets 36a, 36b are substantially the same as the electromagnet 36 described above, except for the reduced size.

The base 130 includes a platform 134 that defines a central slot 136 through which an alternative embodiment of a post 138 is inserted. The electroluminescent device 50 is secured to an open top end 140 of the post 138 with a retaining ring 142, and a bottom end 144 of the post 138 includes a retaining tab 146. Additionally, the post 138 has a spring retention flange 148.

As best illustrated in the cross-sectional view of FIG. 10A with the locking mechanism 129 in a locked position, the retaining tab 146 is engaged to a shoulder 150 within the central slot 136. The retaining tab 146 is further biased upwards against the shoulder 150 as a result of the expansive forces exerted by a helical spring 152 between the spring retention flange 148 and a locking plate 154. In turn, the locking plate 154 defines an aperture 156 through which the platform 134 is received. The locking plate 154 includes lock walls 158 that engage against a top portion 160 of the base 130, also as a result of the expansive forces exerted by the helical spring 152. The offset created by the lock walls 158 position an upper surface 162 of the locking plate 154 against the articulation assembly 30c, thereby raising the same from the base stator assembly 28b, and specifically the domed lens 54.

With reference again to FIG. 9, it is possible to rotate the locking plate 154 via a notch 164 thereon with a corresponding cam 166. To rotate the cam 166, a key 168 may be utilized. This is operative to move the lock walls 158 away from the top portion 160 of the base 130 so that it is no longer in engagement therewith, and lowers the locking plate 154 down from the articulation assembly 30c. In other words, the aforementioned offset created by the lock walls 158 is eliminated, and the articulation assembly 30 is lowered to the base stator assembly 28, as best shown in the cross-sectional view of FIG. 10B. This is achieved with the downward bias from the helical spring 152. The unlocking is understood to be irreversible by the end-user, since an external force to raise the lock walls 158 prior to rotating the same back to engage the top portion 160 of the base 130 would be necessary, and without disassembling the enclosure shell 20 access to the locking plate 154 is limited. Alternatively, the lock walls 158 may have a ramped configuration where the torsion force applied to the cam 166 could also gradually raise the locking plate 154.

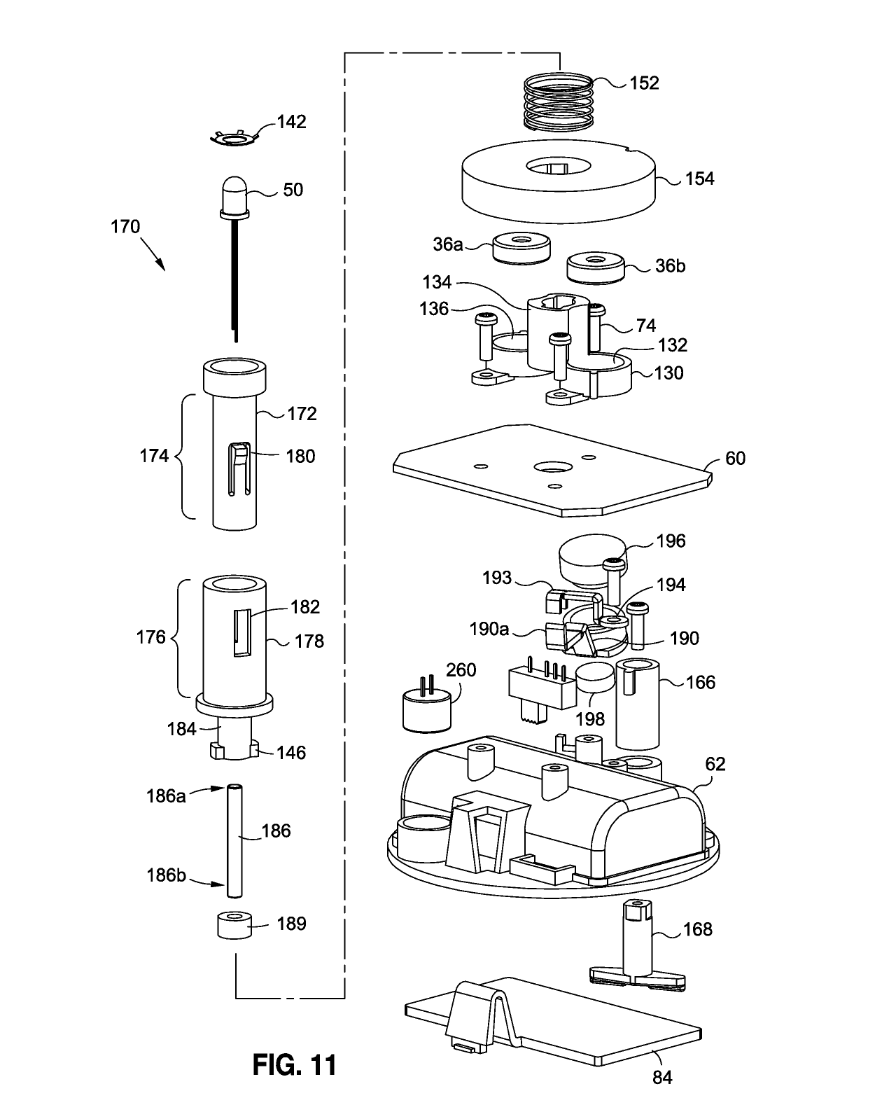

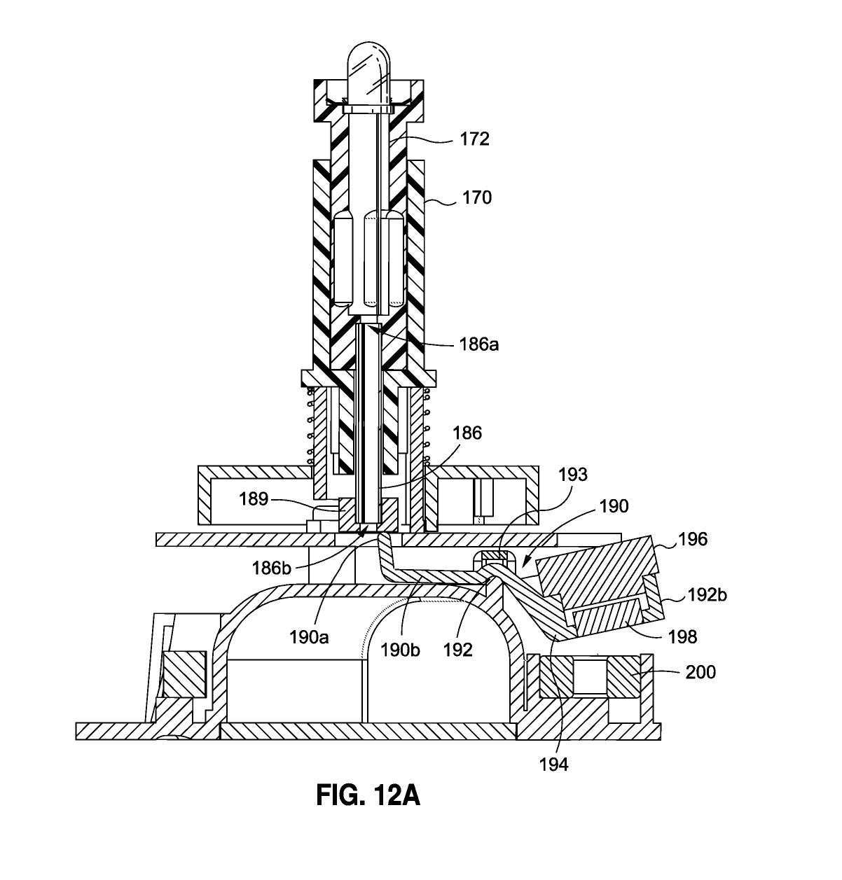

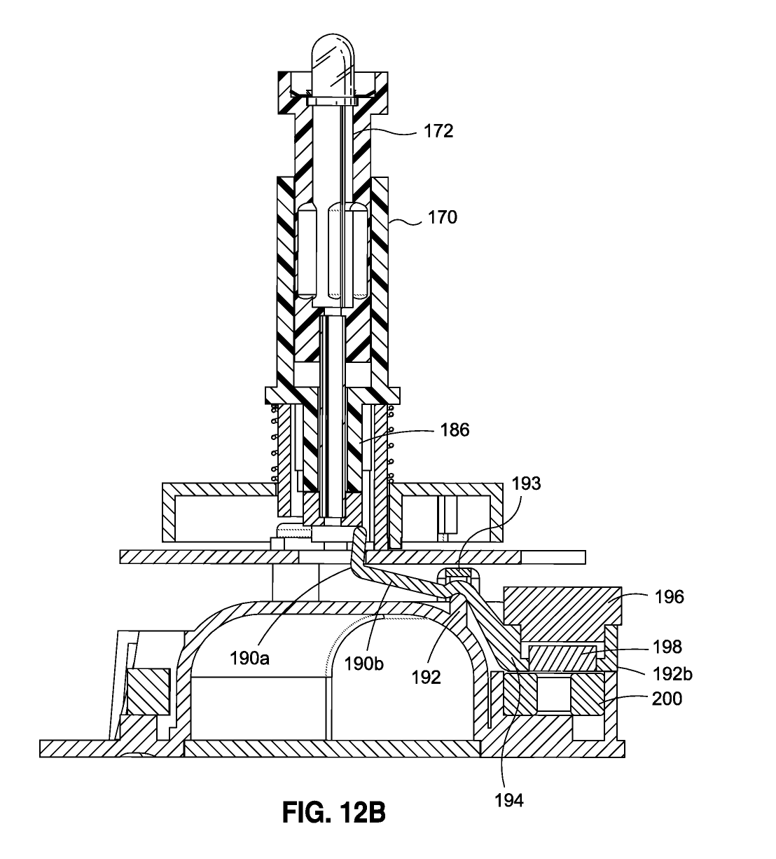

According to another embodiment of the present disclosure, the base stator assembly 28 reciprocates vertically (up and down) along the y axis. This is understood to add yet another degree of motion to the lamp optic 86, rendering the animated illumination 18 more realistic. A first variant is shown in FIG. 11, FIG. 12A, and FIG. 12B. Many of the components are the same as the previously described embodiments, including the circuit board 60, the battery housing 62, and the battery cover 84. Additionally, components specific to the locking mechanism 129 set forth above may be utilized. These include the base 130 with the pair of opposed electromagnet receptacles 132 for receiving the electromagnets 36a, 36b, and further defining the platform 134. Again, the base 130 is secured to the battery housing 62 with the fasteners 74. The locking plate 154, the cam 166, and the key 168 are configured for locked and unlocked positions in accordance with the functionality and features discussed previously.

For the contemplated reciprocation feature, a third embodiment of the base stator assembly 28c utilizes an alternatively configured post 170. Specifically, there is an upper post 172 to which the electroluminescent device 50 is secured via the retaining ring 142. A piston portion 174 is slidably received within a cylinder portion 176 of a lower post 178. In this regard, the piston portion 174 reciprocates up and down relative to the cylinder portion 176. The piston portion 174 of the upper post 172 includes at least one catch 180 that is engageable to a corresponding catch slot 182 defined by the cylinder portion 176 of the lower post 178. Movement of the upper post 172 is limited to the extent of the catch 180 and the catch slot 182. The lower post 178 also has a shaft portion 184 that is similarly configured as the aforementioned embodiment of the post 138, including the retaining tab 146 that engaged with the base 130. With further reference to the cross-sectional views of FIG. 12A and FIG. 12B, there is a connecting rod 186 having a top end 186a that engages the upper post 172, and an opposed bottom end 186b held within a bearing 189. The connecting rod 186 is understood to be hollow for routing the wiring to and from the electroluminescent device 50.

The bearing 189 is in mechanical contact with a lever 190 balanced on a fulcrum point 192. For maintaining the lever 190 on the fulcrum point 192, there is a lever holder 193 secured to the battery housing 62. The lever 190 has a proximal end 190a that extends to mechanically contact the bearing 189. The lever 190 also has an opposed distal end 192b, which defines a receptacle 194 for a weighted counterbalance 196. Also attached to the opposed distal end 192b is a permanent magnet element 198, which interacts with a selectively activatable electromagnet 200 disposed on the battery housing 62. In some embodiments, the permanent magnet element 198 and the weighted counterbalance 196 can be integrated together, although in the illustrated embodiment they are separate components.

When the electromagnet 200 is fully deactivated, the weight comprising the piston portion 174 of the post 170, as well as the articulation assembly 30 suspended therefrom, loads against the connecting rod 186, with such effort being transferred to the lever 190. These components outweigh and overcome the gravitational force of the weighted counterbalance 196 and the permanent magnet element 198. Relative to the view shown in FIG. 12A, this fully pivots the lever 190 to its counterclockwise rotational extent of the battery housing 62.

When the electromagnet 200 is fully activated as shown in FIG. 12B, the electromagnetic attraction force upon the permanent magnet element 198, together with the assisted effort of the gravitational force of the weighted counterbalance 196, overcomes the weight of the piston portion 174 of the post 170, the connecting rod 186, and the articulation assembly 30. Relative to the view shown in FIG. 12B, this fully pivots the lever 190 to its clockwise rotational extent of the electromagnet 200, thereby lifting the piston portion 174 of the post 170.

Intermediate magnetization levels may be applied to produce varying magnetic attraction of the permanent magnet element 198. Along these lines, the magnetization can be time-varied to yield a graduated reciprocating motion.

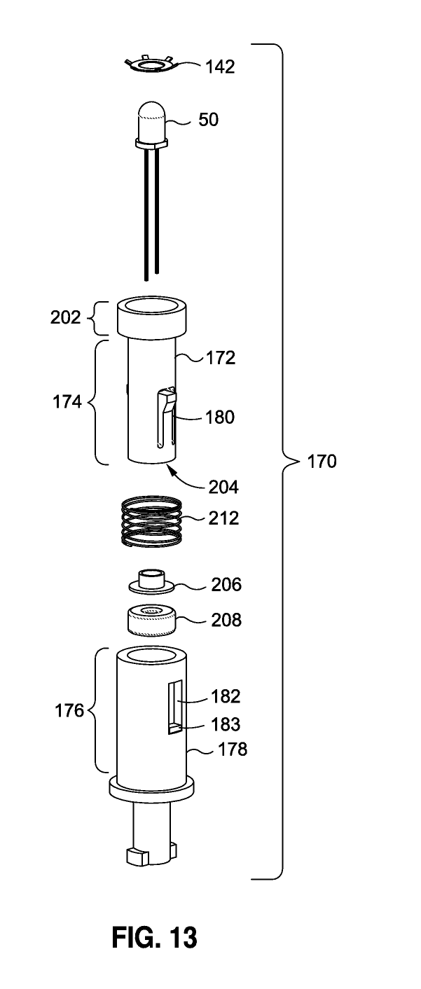

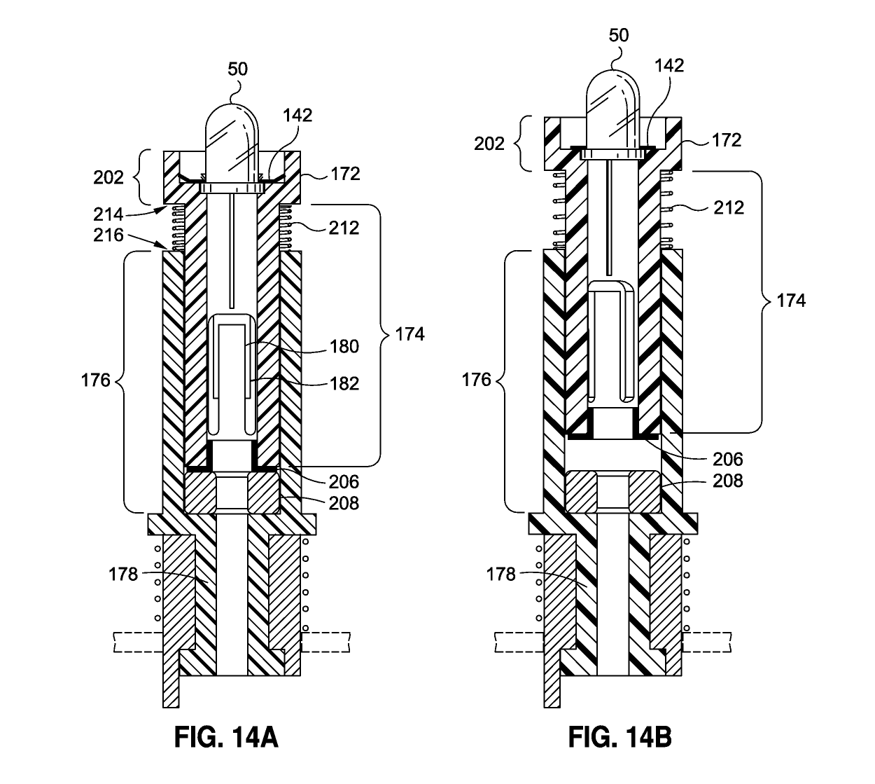

An alternative embodiment in which the base stator assembly 28 (or a component thereof) vertically reciprocates without the above-described lever 190 and related components is also contemplated. Referring now to FIG. 13, FIG. 14A and FIG. 14B, this alternative embodiment utilizes the same post 170 with the upper post 172 and the lower post 178. Again, the electroluminescent device 50 is secured to the top of the upper post 172 with the retaining ring 142. In addition to the piston portion 174, the upper post 172 is defined by a flanged portion 202 that receives the electroluminescent device 50 and the retaining ring 142. The piston portion 174 is slidably received within the cylinder portion 176 of the lower post 178, the limit of extension being defined by the engagement between the catch 180 of the upper post 172 and the catch slot 182 of the lower post 178. At the lower ends of the catch slot 182, cushions 183 constructed of foam or other flexible material may be disposed to soften the shock associated with any contact between the upper post 172 and the lower post 178 during movement. As indicated above, the piston portion 174 reciprocates upwards/downwards relative to the cylinder portion 176.

Such movement of the piston portion 174, that is, the upper post 172, may be induced directly. Accordingly, a bottom end 204 of the piston portion 174 includes a permanent magnet element 206, and the bottom interior of the cylinder portion 176 includes a selectively activatable electromagnet 208. Since the piston portion 174 has a hollow tube configuration, a flanged column that is the permanent magnet element 206 may be retained therein by its inner walls. If additional retention is desired, glue may be applied to the contact surfaces. The electromagnet 208 is similar to those utilized for other kinetic functions described above. Like the wiring for the electroluminescent device 50, any wiring may be routed through the interior of the post 170.

By applying different electrical power levels to the conductive wire of the electromagnet 208, varying levels of attraction and repulsion of the permanent magnet element 206 may be induced. FIG. 14A shows the piston portion 174 minimally extended with the electromagnet 208 deactivated, while FIG. 14B shows the piston portion 174 fully extended with the electromagnet 208 fully energized. Varying levels of electrical power may be provided to the electromagnet 208, and may be time-varied as with the other electromagnets described herein. In one contemplated embodiment, the piston portion 174 is biased extended, i.e., biased toward maximizing the extension of the upper post 172 against the lower post 178. This may be achieved with a buffer spring 212 that is compressed against a shoulder 214 of the flanged portion 202 and a rim 216 of the cylinder portion 176. In this embodiment, the permanent magnet element 206 may be substituted with a ferromagnetic metal, that is, iron.

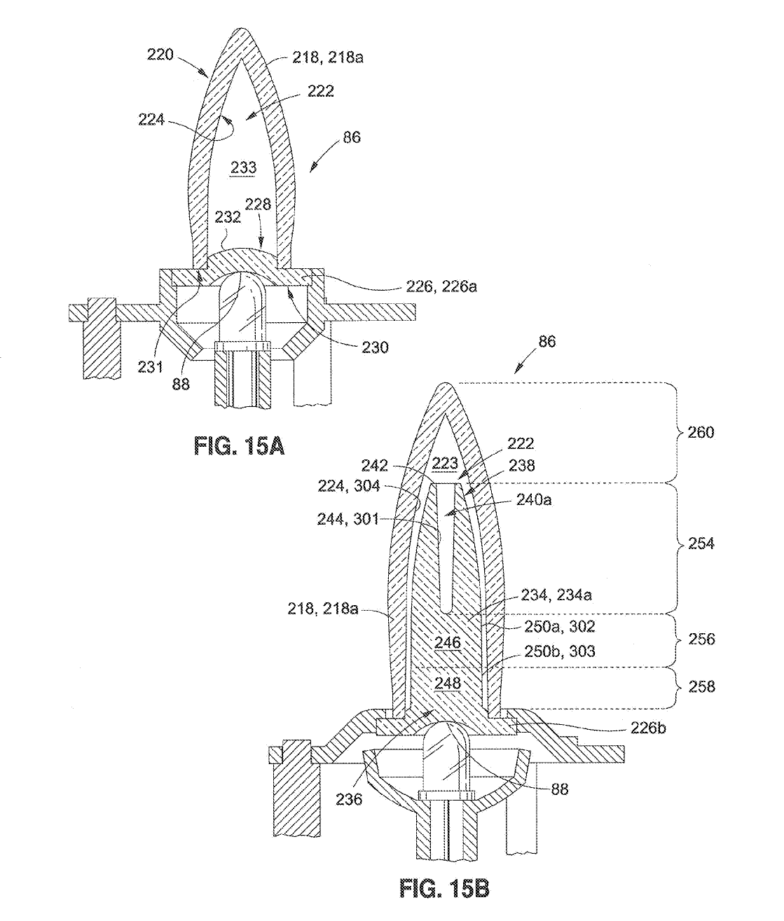

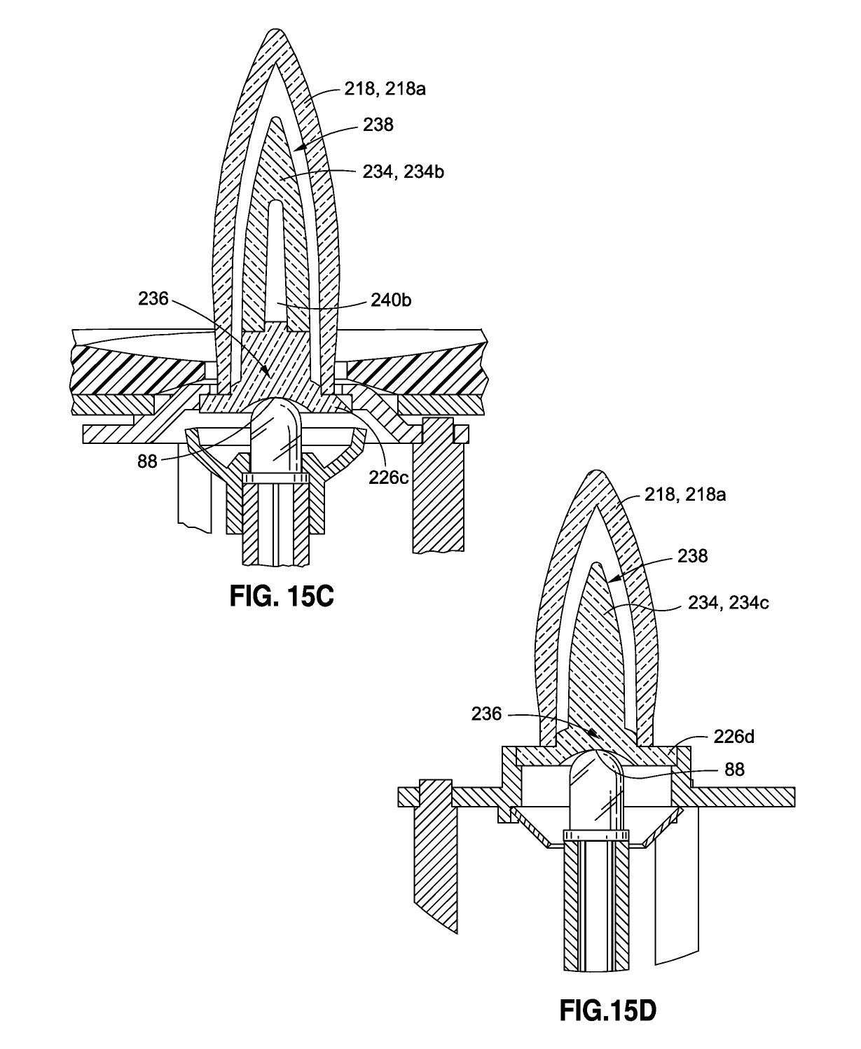

Having considered the kinetic functional features of the artificial flame device 10, the features pertaining to the visual appearance of the generated illumination will now be discussed. FIG. 15A illustrates a basic embodiment of the lamp optic 86 that is part of the articulation assembly 30. More particularly, the lamp optic 86 is comprised of a first embodiment of a cover 218a that defines a flame-shaped exterior 220 with a hollow interior 222. Generally, an interior contour 224 is substantially the same as the contour of the exterior 220, though this is by way of example only and not of limitation. The lamp optic 86 further includes a base element 226, a first embodiment 226a thereof being illustrated. The base element 226 is defined by a first side 228 that interfaces the hollow interior 222 of the cover 218, and an opposed second side 230 that defines the concave surface of the bearing 88.

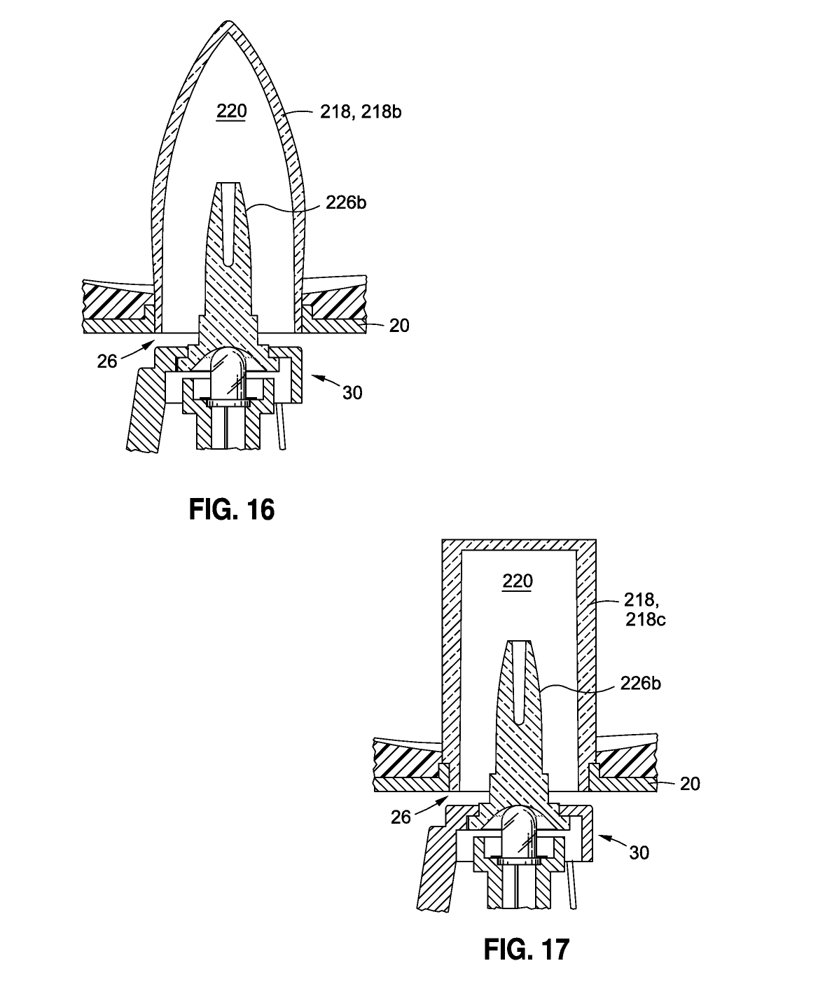

Various embodiments contemplate the base element 226 being attached or otherwise coupled to the cover 218, though in alternative configurations shown in FIG. 16 and FIG. 17, they may be attached to the enclosure shell 20. In such embodiments, the combination of the cover 218 and the base element 226 may nevertheless be referred to as the lamp optic 86 notwithstanding its structural independence. Accordingly, such covers 218 encompass or envelopes the lamp opening 26. As the second and third embodiments of the cover 218b, 218c do not move together with the base element 226b, and the remainder of the articulation assemblies 30, a different illumination effect may be achieved.

It is expressly contemplated that the shape of the cover 218 may be varied according to preference. As shown in the aforementioned FIG. 15A and FIG. 16, the first embodiment of the cover 218a and the second embodiment of the cover 218b may be flame-shaped, that is, characterized by a rounded taper end and a slight inward curvature toward its opposing end. Alternatively, as shown in FIG. 17, the third embodiment of the cover 218c may be cylindrically shaped.

Referring back to the first embodiment of the lamp optic 86 shown in FIG. 15A, in the most basic form, the first side 228 of the base element 226a is a simple dome 232. More particularly, the dome 232 is characterized by a convex surface that is substantially parallel with the concave surface of the bearing 88. The specific geometry of the convex surface/dome 232 may be varied to better focus the light generated by the electroluminescent device 50. To attach the cover 218 to the base element 226, a lip 231 is engageable to the dome 232.

Generally, with all contemplated embodiments, the dome 232 transmits the light through a gap 233 defined between the base element 226 and the cover 218, and against the interior contour 224 of the cover 218a. Each of the light transmissive interfaces of the base element 226 and the cover 218 are understood to have varying diffusion surface layers. Such surfaces are translucent, as opposed to clear, transparent surfaces that do not scatter or diffuse light. One way to yield diffusion surface layers is by sanding or sandblasting the desired surface. Alternatively, the components could be molded with a pre-patterned sanded or matte surface finishing. By overlapping the diffusion surfaces layers, areas of greater or lesser translucency (and hence light output intensity/concentration) may be defined in accordance with various embodiments of the present disclosure. Additional details pertaining to this feature will be described with reference to further embodiments of the lamp optic 86.

Referring to FIG. 15B, another variation of the lamp optic 86 employs the first embodiment of the cover 218a with the aforementioned second embodiment of the base element 226b. In further detail, the base element 226b includes a first embodiment of a vertically extending light pipe 234a that is generally defined by a proximal end 236 that is adjacent to the bearing 88 and an opposed, tapered distal end 238.

In the illustrated embodiment of FIG. 15B, the light pipe 234a defines a centered axial bore 240a with an opening 242 on the distal end 238. Alternatively, as shown in FIG. 15C, a second embodiment of the light pipe 234b likewise defines another variation of a centered axial bore 240b that is within the interior thereof without an opening. In each embodiment, the axial bore 240 extends partially through the light pipe 234. Further still, as best shown in FIG. 15D, a third embodiment of the light pipe 234c may entirely omit the axial bore 240.

With reference again to FIG. 15B, the centered light pipe 234a, at the axial bore 240a, defines a bore surface 244 has a translucent finish that diffuses light, and is also referred to as a first diffusion surface layer 301. The light pipe 234a can be further segregated into a first section 246 and a second section 248, with a light pipe outer surface 250a of the first section 246 defining a second diffusion surface layer 302, and a light pipe outer surface 250b of the second section 248 defining a third diffusion surface layer 303. In accordance with one embodiment, the light pipe outer surface 250a has a translucent matte or sanded finish that diffuses light, but the light pipe outer surface 250b has a transparent finish that transmits light with minimal diffusion. Furthermore, the interior contour 224 of the cover 218a is likewise understood to have a translucent matte or sanded finish that diffuses light, and accordingly defines a fourth diffusion surface layer 304.

From the exterior of the lamp optic 86, based on the various diffusion surface layers 301-304, several distinct regions or areas that exhibit varying reflection and refraction densities emerge. In a first region 254 in which the first diffusion surface layer 301, the second diffusion surface layer 302, and the fourth diffusion surface layer 304 overlap. This is where the maximum light reflection and refraction occurs. This is intended to coincide with the most intensely colored and illuminated region of a natural flame.

In a second region 256, the second diffusion surface layer 302 and the fourth diffusion surface layer 304 overlap, and is accordingly slightly more transparent relative to the first region 254, and the light does not reflect and refract within as much. This is intended to coincide with a less intense illuminated region below the center of a natural flame.

In a third region 258, the transparent, third diffusion surface layer 303 and the fourth diffusion surface layer 304 overlap. Because the light from the electroluminescent device 50 is traveling in a substantially parallel relationship to the light pipe outer surface 250b, very little light is refracted thereto. Hence, even with the overlapping fourth diffusion surface 304, light output at the third region 258 is minimal, mimicking the dark appearance of the lowest part of a natural flame.

On the opposite end, in a fourth region 260, the light output from the light pipe 234a as reflected and refracted through the axial bore 240a is more intense than that output from the second region 256. This light is further refracted and reflected by the fourth diffusion surface layer 304 of the cover 218a, and has a more pronounced intensity gradient than in other regions.

Those having ordinary skill in the art will recognize that each of the aforementioned diffusion surface layers 301-304, including the surface areas and level of translucency/transparency thereof, can be varied and optimized to better mimic the appearance of a natural flame. Thus, the foregoing example is not intended to be limiting, and any other suitable arrangement of diffusion surface layers may be substituted without departing from the scope of the present disclosure. Along these lines, based on the foregoing example, it will be appreciated that different diffusion surface layers may be defined in the alternative embodiments of the lamp optic 86 shown in FIGS. 15C and 15D.

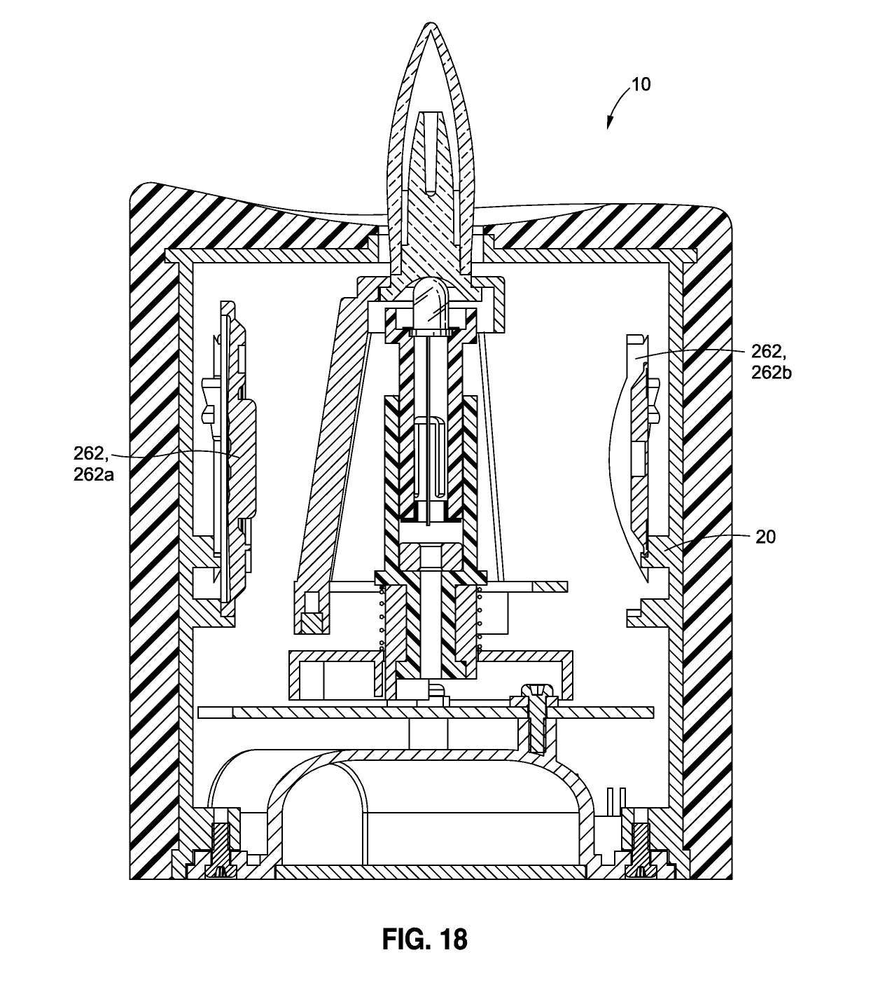

Beyond illumination and movement, it is contemplated that the artificial flame device 10 also outputs pre-programmed sounds, musical tracks, and the like. In this regard, there may be a separate sound circuit included with the integrated circuit or the circuit board 60, as well as one or more acoustic transducers 262 that output audible sound. As shown in FIG. 18, it is expressly contemplated that the acoustic transducer 262 include a speaker 262a as well as a piezo buzzer 262b, both of which are mounted to a sidewall of the enclosure shell 20.

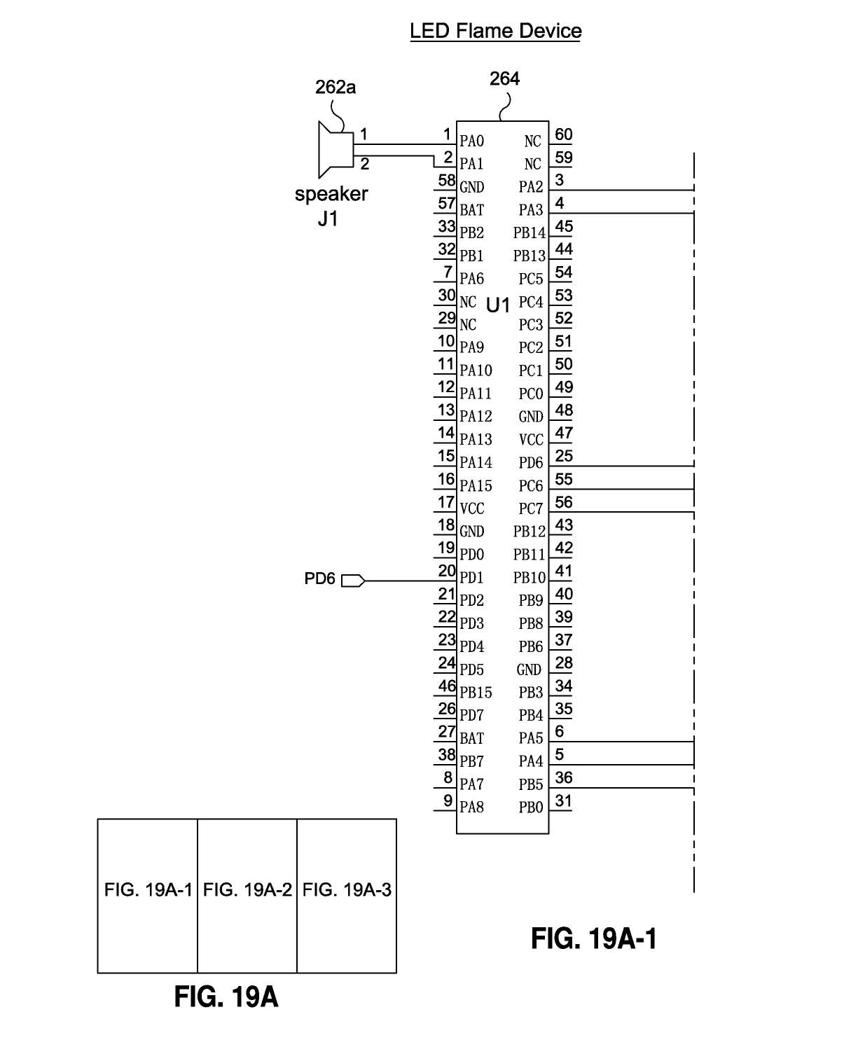

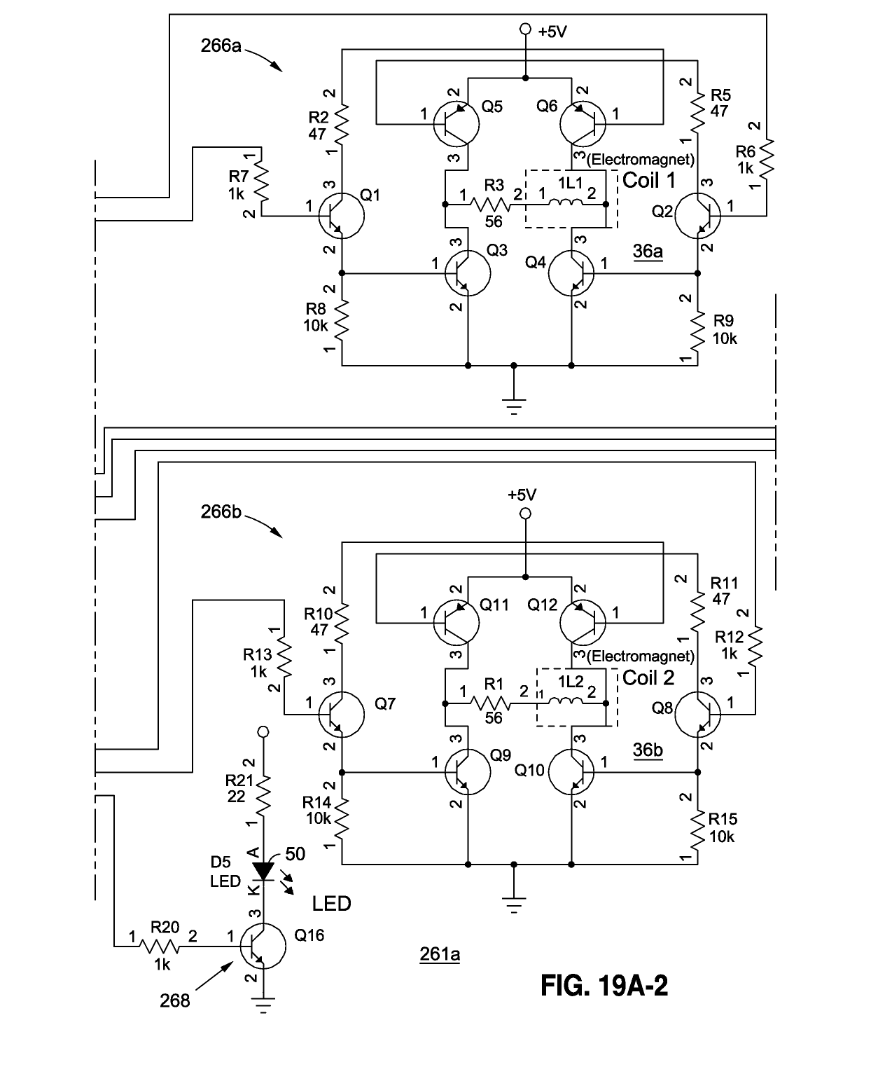

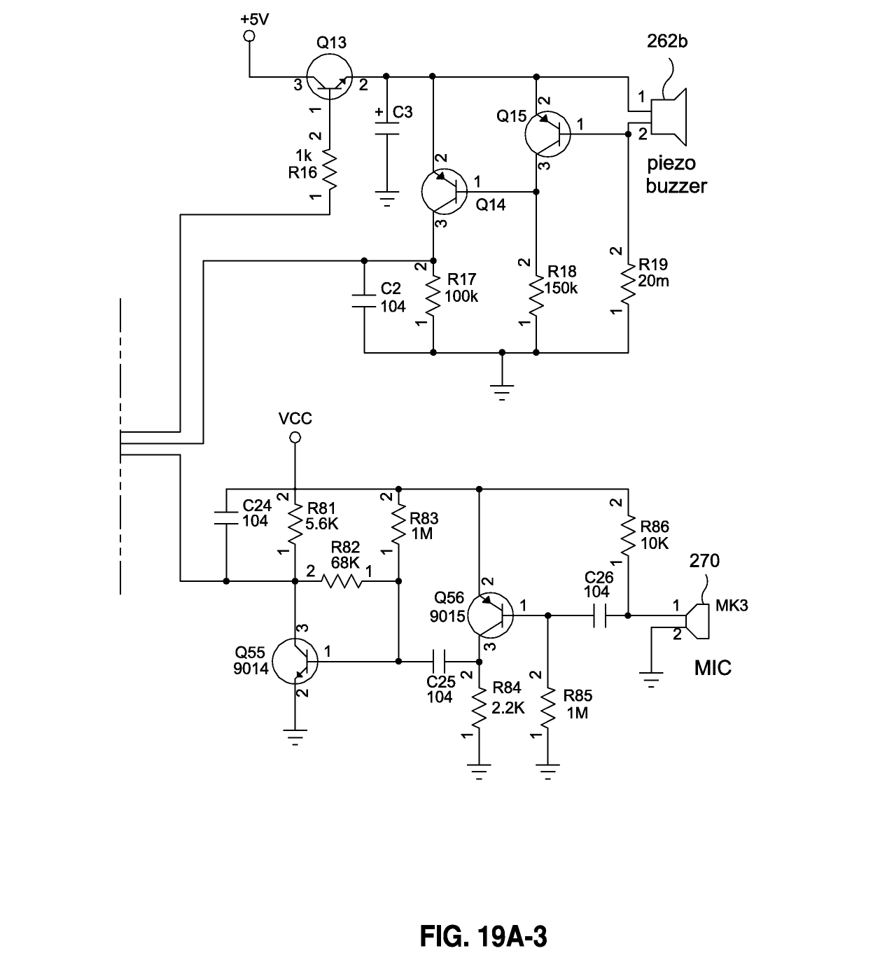

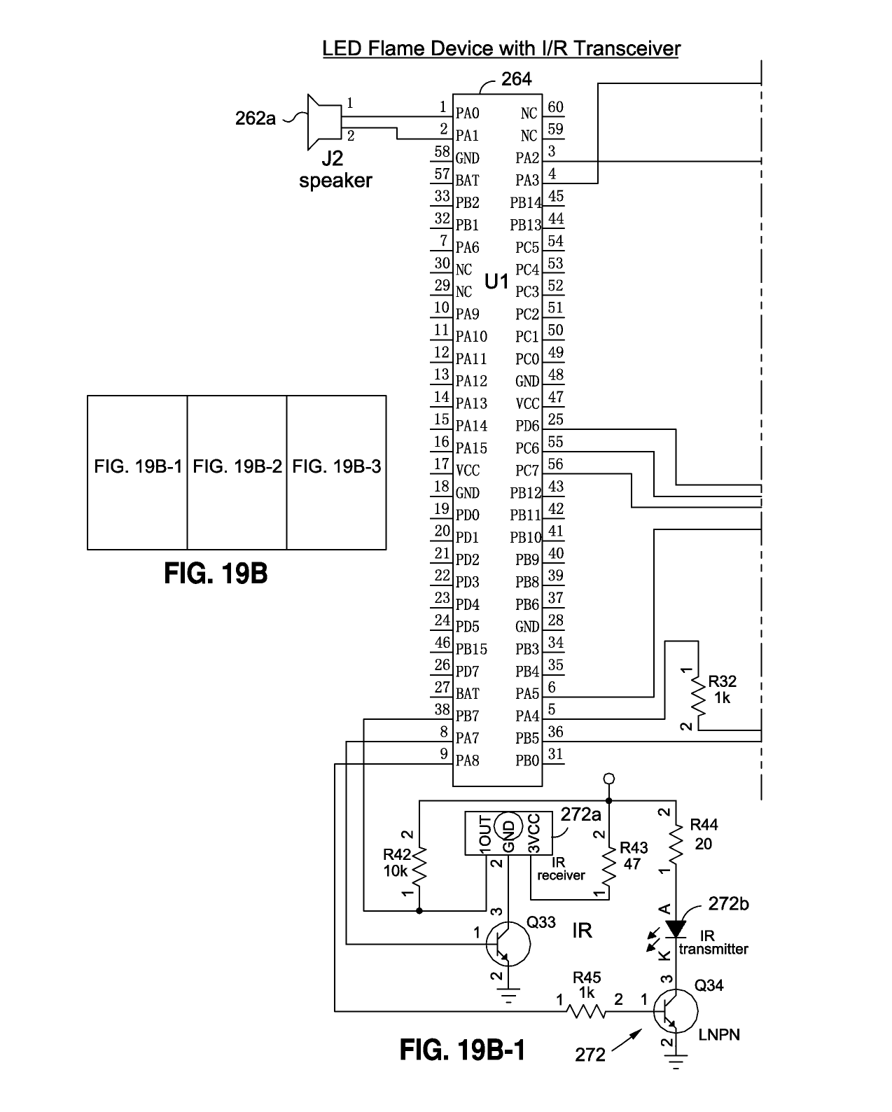

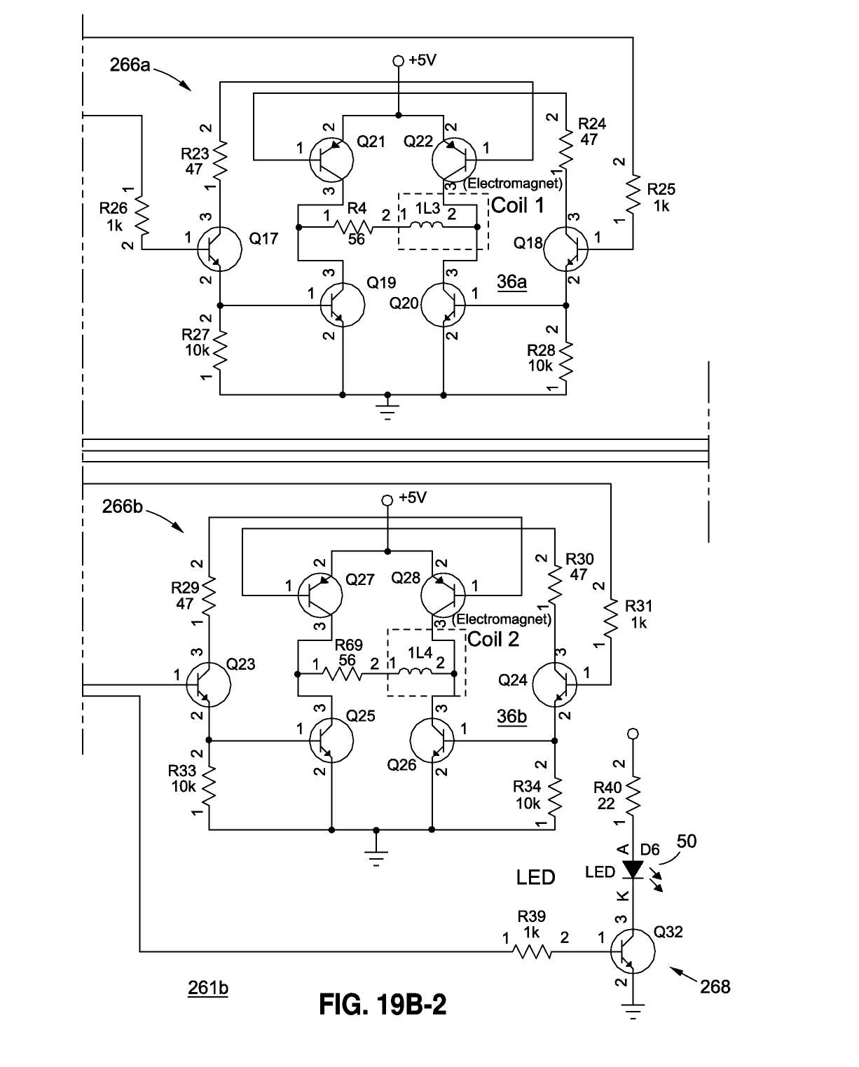

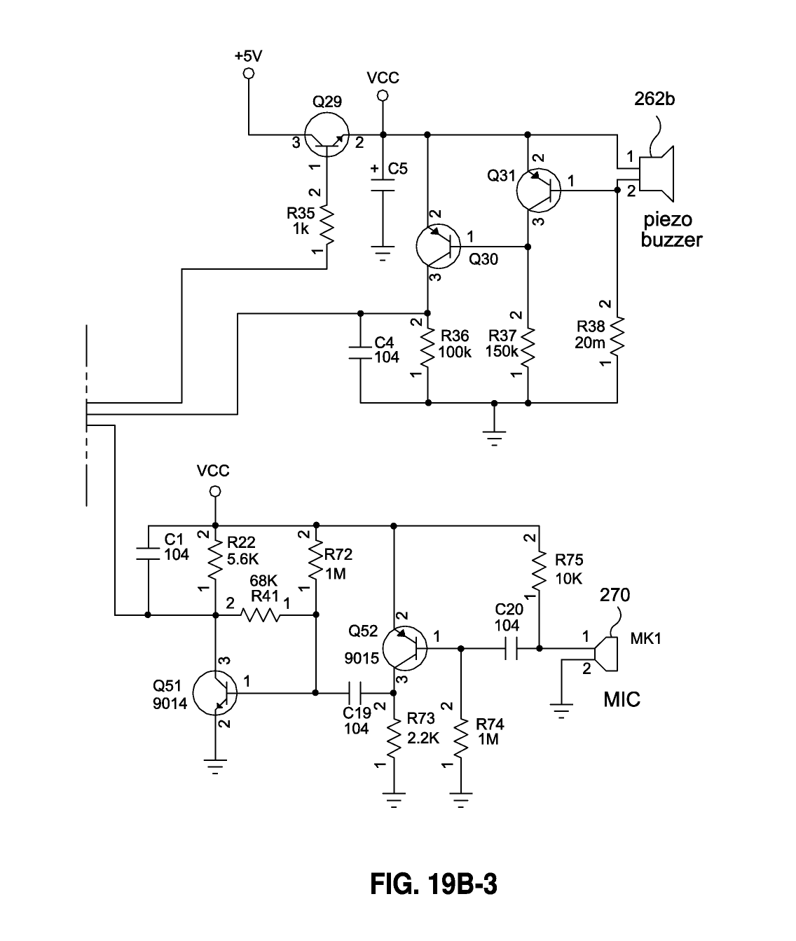

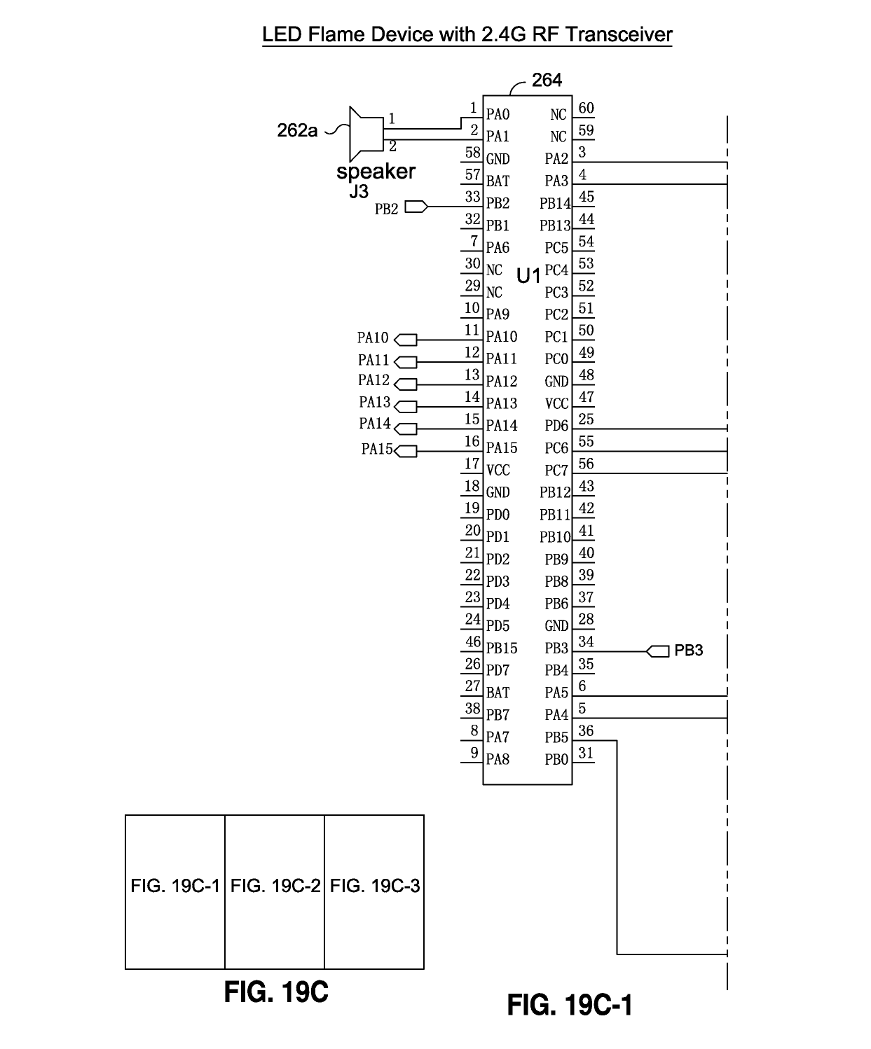

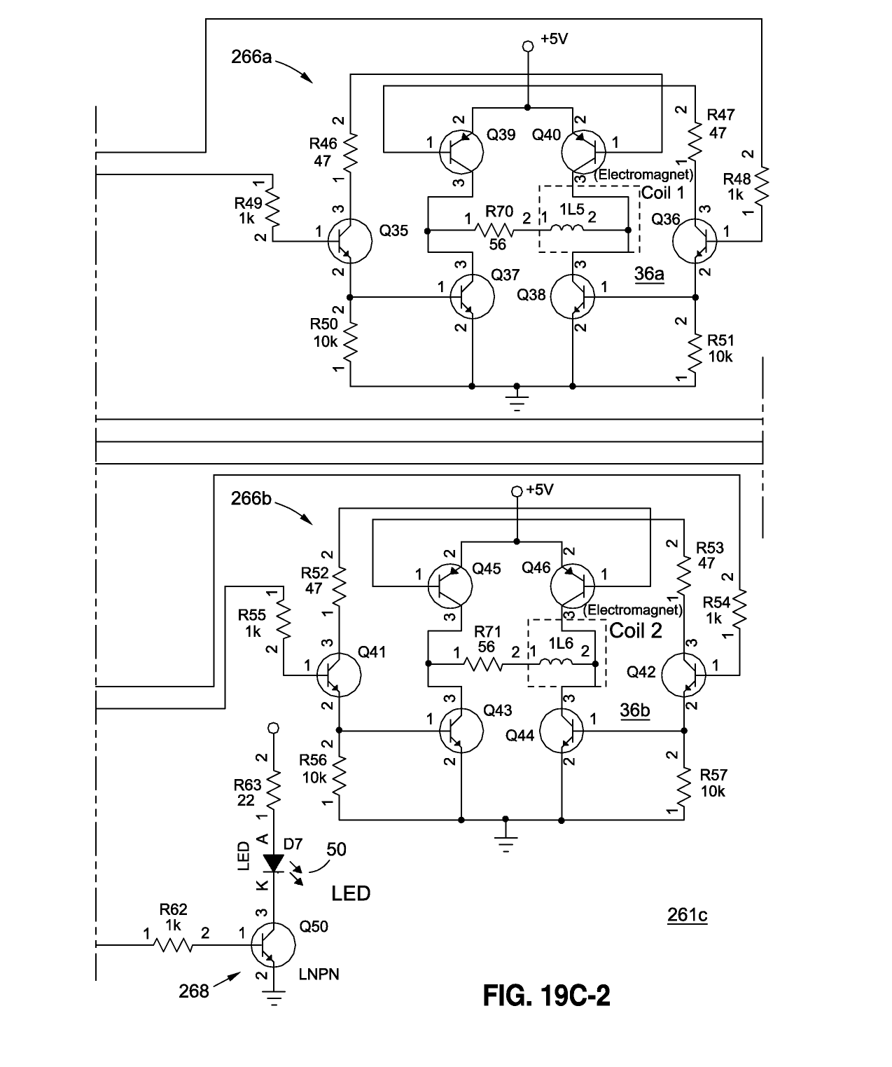

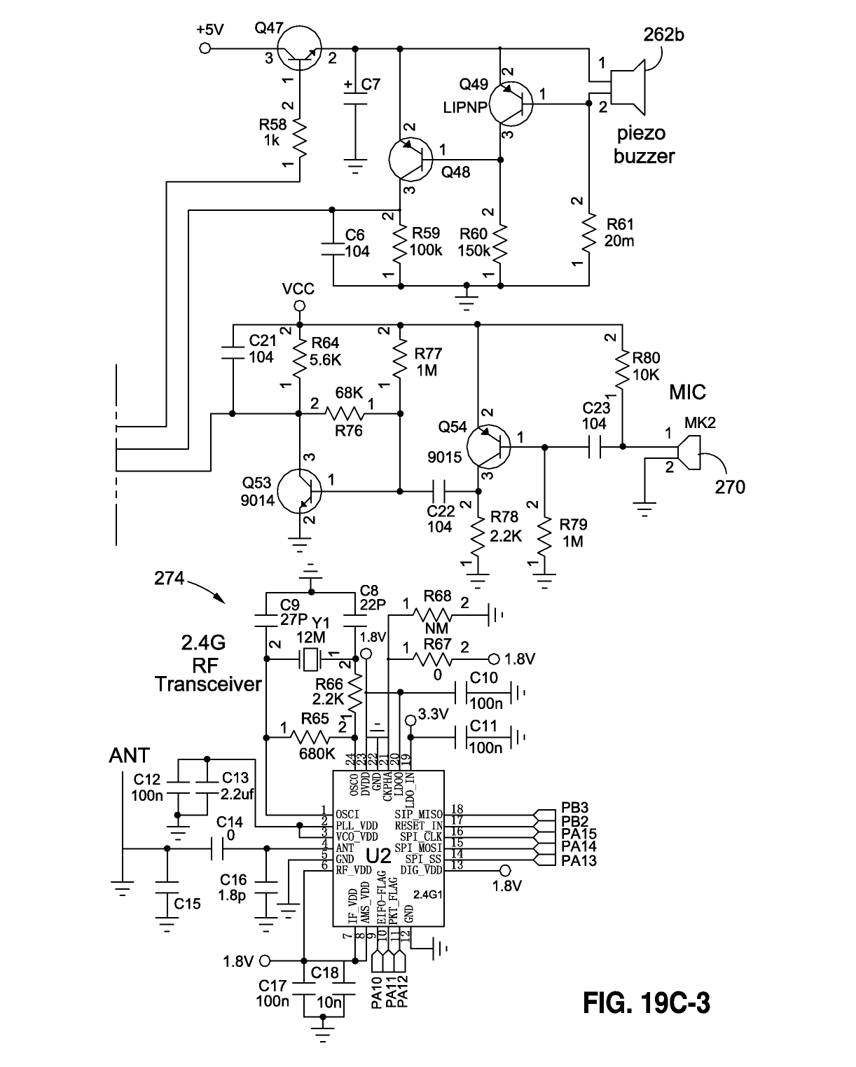

With reference to the circuit diagrams of FIG. 19A-19C there are various embodiments of a circuit 261a-261c implemented on the circuit board 60 as mentioned above. In the illustrated embodiments, the speaker 262a and the piezo buzzer 262b are connected to outputs of a microcontroller 264. According to several of the above-described embodiments, movement of the articulation assembly 30 is variably induced by the electromagnet 36, and in particular, the first electromagnet 36a and the second electromagnet 36b. Each of the electromagnets 36a, 36b are powered by respective electromagnet driver circuits 266a, 266b, which are connected to yet another set of outputs of the microcontroller 264. Furthermore, as mentioned above, the illumination output of the electroluminescent device 50 is also variable, and is accordingly controlled by the microcontroller 264. As with the other devices, there is an illumination driver circuit 268 that boosts signal power levels to the electroluminescent device 50.

While the sequence of outputs (illumination, movement, or sound) may be pre-programmed in some embodiments of the artificial flame device 10, external inputs that modify such outputs is also contemplated. For example, instructions generated from another, external device may be received by the microcontroller 264 to output a particular sound in response, move the articulation assembly 30 in a particular way, or flicker the electroluminescent device 50 in a particular sequence. A variety of input modalities are contemplated, including a microphone 270 as utilized in the first embodiment of the circuit 261a shown in FIG. 19A-1, FIGS. 19A-2, and 19A-3. With reference to the example shown in FIG. 11, the microphone 270 may be mounted to the battery housing 62. The microcontroller 264 may be programmed to recognize certain sequences of audible or inaudible tones or signals as corresponding to commands to generate a specific output to the electromagnets 36, 200, 208, the electroluminescent device 50, or the acoustic transducers 262. FIG. 19B-1, FIG. 19B-2, and FIG. 19B-3 illustrate an alternative in which the input modality is an infrared transceiver 272 comprised of a receiver 272a and a transmitter 272b. In this regard, it is also possible to coordinate functionality with other similarly configured artificial flame device 10 to which an IR data communications session can be established. Still further, as shown in FIG. 19C-1, FIG. 19C-2, and FIG. 19C-3, the input modality can be a radio frequency (RF) transceiver 274. Those having ordinary skill in the art will recognize the requisite configuration of these remote data transmission modalities, and how the microcontroller 264 is to be programmed therefor.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. An artificial flame device comprising:
an enclosure defining a lamp opening;
a base stator assembly including a base with a selectively activatable electromagnet, a post extending therefrom, and an electroluminescent device with a lens mounted on the post; and
an articulation assembly suspended from the base stator assembly, the articulation assembly including a lamp optic defining a bearing coupled to the lens and at least one extension defining a magnetic distal end interacting with the electromagnet of the base in response to a selective activation thereof to induce rotation and movement of the articulation assembly within a predefined conical volume;
wherein the base stator assembly and the articulation assembly are at least partially disposed within the enclosure, the lamp optic protruding from the lamp opening of the enclosure and diffusing light from the electroluminescent device passed thereto.

2. The artificial flame device of claim 1, wherein the lamp optic includes a hollow cover element coupled to a base element defined by a first side interfacing an interior of the cover element and an opposed, second side defining the bearing.

3. The artificial flame device of claim 2, wherein the first side of the base element includes a vertically extending light pipe having a contour substantially conforming to an interior of the hollow cover element.

4. The artificial flame device of claim 2, wherein the cover element and the base element define a plurality of overlapping regions of diffusion surface layers, the light from the electroluminescent device being diffused in varying degrees based upon the specific one of the regions from which the light is output.

5. The artificial flame device of claim 1, further comprising:
a cover enclosing the lamp optic;
wherein the lamp optic includes a base element defined by a first side interfacing an interior of the cover and an opposed, second side defining the bearing.

6. The artificial flame device of claim 5, wherein the cover is fixed to the enclosure and envelopes the lamp opening of the enclosure.

7. The artificial flame device of claim 5, wherein the cover is flame-shaped.

8. The artificial flame device of claim 5, wherein the cover is cylindrically shaped.

9. The artificial flame device of claim 1, wherein the enclosure has a generally cylindrical shape.

10. The artificial flame device of claim 1, wherein the lens is an integral part of a packaging of the electroluminescent device.

11. The artificial flame device of claim 1, wherein the lens is part of a lens adapter engaged with the electroluminescent device.

12. The artificial flame device of claim 1, further comprising:
a light regulator circuit that periodically varies an intensity of light output from the electroluminescent device.

13. The artificial flame device of claim 1, further comprising:
a movement regulator circuit that selectively activates the electromagnet.

14. The artificial flame device of claim 1, further comprising:
an audio transducer disposed within the enclosure; and
a sound circuit connected to the audio transducer to generate a predetermined audible output.

15. The artificial flame device of claim 1, further comprising:
a battery housing disposed within the enclosure; and
a battery powering the electroluminescent device and the electromagnet;
wherein the battery is stored inside the battery housing.

16. The artificial flame device of claim 1, further comprising:
a lock plate coupled to the base stator assembly and having a locked position in which the post is decoupled from the articulation assembly and an unlocked position in which the post is coupled with the articulation assembly.

17. The artificial flame device of claim 1, wherein the post of the base stator assembly reciprocates along a central axis thereof.

18. A lamp optic for simulating a flame in cooperation with an electroluminescent device, comprising:
a cover with a hollow interior;
a base defined by a first side interfacing an interior of the cover and an opposed, second side defining a bearing surface engageable to a lens focally aligned with a radiation axis of the electroluminescent device, the cover being coupled to the base; and
a gap defined between the cover and the base;
wherein light generated by the electroluminescent device is transmitted to the base through the bearing surface thereof and dispersed through the base and the cover, the cover and the base defining a plurality of overlapping regions of diffusion surface layers that reflects and refracts the light in varying degrees depending on the specific region from which the light is output, the regions being arranged for a resultant light output to simulate varying illumination intensity areas of a natural flame.

19. The lamp optic of claim 18, wherein the first side of the base includes a vertically extending light pipe defined by a proximal end adjacent to the bearing surface and an opposed distal end.

20. The lamp optic of claim 19, wherein the light pipe is tapered toward the distal end thereof.

21. The lamp optic of claim 19, wherein the light pipe defines a centered axial bore extending partially through the light pipe.

22. The lamp optic of claim 21, wherein the distal end of the light pipe defines an opening of the centered axial bore.

23. The lamp optic of claim 22, wherein:
a bore surface of the centered axial bore has a translucent, diffusion surface and defines a first diffusion surface layer;
a first section of an external surface of the light pipe has a translucent, diffusion surface and defines a second diffusion surface layer;
a second section of the external surface of the light pipe has a transparent surface and defines a third diffusion surface layer; and
an interior surface of the cover has a translucent, diffusion surface, and defines a fourth diffusion surface layer.

24. The lamp optic of claim 23, wherein a first region of maximized light reflection and refraction density is defined by an overlapping area of the first diffusion surface layer, the second diffusion surface layer, and the fourth diffusion surface layer.

25. The lamp optic of claim 23, wherein a second region of intermediate light refraction and reflection density is defined by an overlapping area of the second diffusion surface layer and the fourth diffusion surface layer.

26. The lamp optic of claim 23, wherein a third region of minimal light refraction and reflection density is defined by an overlapping area of the third diffusion surface layer and the fourth diffusion surface layer.

27. The lamp optic of claim 21, wherein the distal end of the light pipe is closed.

28. The lamp optic of claim 18, wherein the first side of the base has a convex surface substantially parallel with a concave surface defined by the bearing surface.

29. The lamp optic of claim 18, wherein the first side of the base defines a protuberance engageable with a corresponding rim of the cover.

30. A flame simulation apparatus, comprising:
a stator base including a selectively activatable first electromagnet;
a post extending from the stator base including an electroluminescent device mounted thereon with a case defining a first joint element;
a lamp optic assembly with a bearing surface defining a second joint element rotatably engaged to the first joint element of the case, an interface of the bearing surface and the case defining a pivot point;
a swing plate with the lamp optic assembly coaxially mounted thereto; and
at least one extension from the swing plate including a magnetic element that interacts with the first electromagnet to induce movement of the swing plate about the pivot point.

31. The flame simulation apparatus of claim 30, wherein the interface of the bearing surface and the case substantially mimics a range of motion of a ball and socket joint.

32. The flame simulation apparatus of claim 31, wherein the bearing surface has a concave shape.

33. The flame simulation apparatus of claim 31, wherein the bearing surface has a convex shape.

34. The flame simulation apparatus of claim 31, wherein the bearing surface has a conical shape.

35. The flame simulation apparatus of claim 31, wherein the bearing surface is flat.

36. The flame simulation apparatus of claim 30, wherein the at least one extension includes a plurality of swing arms attached to the swing plate, a proximal end of the swing arms being attached to the swing plate and a distal end of the swing arms including the magnetic element.

37. The flame simulation apparatus of claim 36, wherein the swing arms are spaced equidistantly from each other around a circumference of the swing plate.

38. The flame simulation apparatus of claim 36, further comprising:
an annular track extending around and attached to each of the extensions; and
a counterweight freely moving within the annular track.

39. The flame simulation apparatus of claim 30, wherein the post reciprocates along a central axis thereof.

40. The flame simulation apparatus of claim 39, further comprising:
a lever balanced on a fulcrum point and having a proximal end connected to the post and a distal end including a weighted magnetic counterbalance;
a selectively activatable second electromagnet disposed under the weighted magnetic counterbalance that interacts with the weighted magnetic counterbalance to induce axial movement of the post.

41. The flame simulation apparatus of claim 39, wherein the post has a piston portion reciprocating within a cylinder portion, the piston portion including a magnet that interacts with an selectively activatable electromagnet disposed within the cylinder portion.

42. The flame simulation apparatus of claim 41, further comprising:
a buffer spring compressed against the cylinder portion and the piston portion.

43. The flame simulation apparatus of claim 30, further comprising:
a reflector attached to the post underneath the electroluminescent device.

44. The flame simulation apparatus of claim 30, wherein the electromagnet includes a first coil disposed opposite a second coil.
